(19) United States
(12) Patent Application Publication
(10) Pub. No.: US 2014/0286411 A1
(43) Pub. Date: Sep. 25, 2014

(54) METHOD AND APPARATUS FOR SCALABLE VIDEO ENCODING AND METHOD AND APPARATUS FOR SCALABLE VIDEO DECODING

(71) Applicant: SAMSUNG ELECTRONICS CO., LTD., Suwon-si (KR)

(72) Inventors: Seung-soo JEONG, Seoul (KR); Chan-yul KIM, Bucheon-si (KR); Tammy LEE, Seoul (KR); Young-ho MOON, Suwon-si (KR); Jeong-hoon PARK, Seoul (KR)

(73) Assignee: SAMSUNG ELECTRONICS CO., LTD., Suwon-si (KR)

(21) Appl. No.: 14/219,397

(22) Filed: Mar. 19, 2014

(30) Foreign Application Priority Data
Mar. 19, 2013 (KR) 10-2013-0029249

(51) Int. Cl. H04N 19/30; H04N 19/593

(52) U.S. Cl. CPC H04N 19/00424; H04N 19/00763
USPC 375/240.12

(57) ABSTRACT

Provided are scalable video encoding and decoding methods. The scalable video encoding method includes: obtaining a peripheral pixel of an enhancement block based on a peripheral pixel of a base layer block corresponding to the enhancement layer block to be prediction-encoded, and performing intra prediction on the enhancement layer block by using at least one of a peripheral pixel of the enhancement layer block that is encoded before the enhancement layer block and then restored and a peripheral pixel of the enhancement layer block that is obtained based on a peripheral pixel of the base layer block.

### RELATED APPLICATIONS

This application claims priority from Korean Patent Application No. 10-2013-0029249, filed on Mar. 19, 2013 in the Korean Intellectual Property Office, the disclosure of which is incorporated herein in its entirety by reference.

### BACKGROUND

1. Field

Exemplary embodiments relate to methods and apparatuses for scalable video encoding and decoding.

2. Description of the Related Art

In general, image data is encoded according to a predetermined data compression standard such as Moving Picture Expert Group (MPEG) and encoded data is stored in an information storage medium as a bitstream or is transmitted through a communication channel to other devices.

Scalable video coding (SVC) is an example of a video compression method for appropriately adjusting a data amount for transmission of videos according to various communication networks and terminals. In SVC, encoded videos having various layers are included in a bitstream so that services may be adaptively provided to various transmission networks and reception terminals.

According to SVC, a video is encoded using a restricted encoding method based on a macroblock of a predetermined size.

### SUMMARY

Exemplary embodiments include an interlayer inter prediction structure for intra predicting an enhancement layer image by using a base layer image.

Additional aspects will be set forth in part in the description which follows, will be apparent from the description, or may be learned by practice of the exemplary embodiments.

According to an exemplary embodiment, a scalable video encoding method includes: encoding a base layer block; restoring the encoded base layer block; obtaining a peripheral pixel of an enhancement layer block based on a peripheral pixel of the base layer block corresponding to the enhancement layer block to be prediction-encoded; and performing intra prediction on the enhancement layer block by using at least one of a peripheral pixel of the enhancement layer block that is encoded before the enhancement layer block and then restored and a peripheral pixel of the enhancement layer block that is obtained based on a peripheral pixel of the base layer block.

According to an exemplary embodiment, a scalable video encoding apparatus includes: a base layer encoder that encodes a base layer block; and an enhancement layer encoder that obtains a peripheral pixel of the enhancement layer block based on a peripheral pixel of a base layer block corresponding to an enhancement layer block to be prediction-encoded, and that prediction encodes the enhancement layer block by performing intra prediction on the enhancement layer block by using at least one of a peripheral pixel of the enhancement layer block that is encoded before the enhancement layer block and then restored, and a peripheral pixel of the enhancement layer block obtained based on a peripheral pixel of the base layer block.

According to an exemplary embodiment, a scalable video decoding method comprising: obtaining encoding information of a base layer block and encoding information of an enhancement layer block by parsing a bitstream; decoding the base layer block based on the encoding information of the base layer block; obtaining a peripheral pixel of the enhancement layer block based on a peripheral pixel of the decoded base layer block corresponding to the decoded enhancement layer block; and performing intra prediction on the enhancement layer block by using at least one of a peripheral pixel of an enhancement layer block that is restored before the enhancement layer block and a peripheral pixel of the enhancement layer block that is obtained based on a peripheral pixel of the base layer block, according to a prediction mode of the enhancement layer block.

According to an exemplary embodiment, a scalable video decoding apparatus includes: a parser that obtains encoding information of a base layer block and encoding information of an enhancement layer block by parsing a bitstream; a base layer decoder that decodes the base layer block based on the encoding information of the base layer block; and an enhancement layer decoder that obtains a peripheral pixel of the enhancement layer block based on a peripheral pixel of the decoded base layer block corresponding to a decoded enhancement layer block, and performs intra prediction on the enhancement layer block by using at least one of a peripheral pixel of an enhancement layer block that is decoded before the enhancement layer block and a peripheral pixel of the enhancement layer block that is obtained based on a peripheral pixel of the base layer block, according to a prediction mode of the enhancement layer block.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a block diagram of an apparatus for encoding a video, according to an exemplary embodiment;

FIG. 2 is a block diagram of an apparatus for decoding a video, according to an exemplary embodiment;

FIG. 3 is a diagram for describing a concept of coding units according to an exemplary embodiment;

FIG. 4 is a block diagram of an image encoder based on coding units according to an exemplary embodiment;

FIG. 5 is a block diagram of an image decoder based on coding units according to an exemplary embodiment;

FIG. 6 is a diagram illustrating deeper coding units according to depths, and partitions according to an exemplary embodiment;

FIG. 7 is a diagram for describing a relationship between a coding unit and transformation units, according to an exemplary embodiment;

FIG. 8 is a diagram for describing encoding information of coding units corresponding to a coded depth, according to an exemplary embodiment;

FIG. 9 is a diagram of deeper coding units according to depths, according to an exemplary embodiment;

FIGS. 10 through 12 are diagrams for describing a relationship between coding units, prediction units, and transformation units, according to an exemplary embodiment;

FIG. 13 is a diagram for describing a relationship between a coding unit, a prediction unit or a partition, and a transformation unit, according to encoding mode information of Table 1;

FIG. 14 is a block diagram illustrating a scalable video encoding apparatus according to an exemplary embodiment;

FIG. 15 is a block diagram illustrating a scalable video decoding apparatus according to an exemplary embodiment;

FIG. 16 is a detailed block diagram of a scalable encoding apparatus according to an exemplary embodiment;

FIG. 17 illustrates a relationship between a block of a base layer corresponding to a current block of an enhancement layer and a peripheral pixel of the base layer corresponding to a peripheral pixel of the enhancement layer, according to an exemplary embodiment;

FIG. 18 illustrates a relationship between a peripheral pixel of an enhancement layer used in a current block of the enhancement layer and a peripheral pixel of the enhancement layer obtained from a base layer image, according to an exemplary embodiment;

FIG. 19 illustrates an intra prediction mode used in intra prediction of a base layer image and an enhancement layer image, according to an exemplary embodiment;

FIG. 20 is a reference diagram for explaining intra prediction modes having various directivities, according to an exemplary embodiment;

FIGS. 21A through 21D illustrates various examples of obtaining a peripheral pixel of a current block of an enhancement layer from a base layer image, according to an exemplary embodiment;

FIG. 22 illustrates direct current (DC) intra prediction modes of a current block of an enhancement layer, according to an exemplary embodiment;

FIG. 23 is a flowchart illustrating a scalable video encoding method according to an exemplary embodiment;

FIG. 24 is a detailed block diagram illustrating a scalable decoding apparatus according to an exemplary embodiment; and

FIG. 25 is a flowchart illustrating a scalable video decoding method according to an exemplary embodiment.

### DETAILED DESCRIPTION

Reference will now be made in detail to exemplary embodiments, examples of which are illustrated in the accompanying drawings, wherein like reference numerals refer to the like elements throughout. In this regard, the exemplary embodiments may have different forms and should not be construed as being limited to the descriptions set forth herein. Accordingly, the description provided below refers to the figures to explain aspects of the exemplary embodiments. Expressions such as “at least one of,” when preceding a list of elements, modify the entire list of elements and do not modify the individual elements of the list.

Exemplary embodiments will now be described more fully with reference to the accompanying drawings.

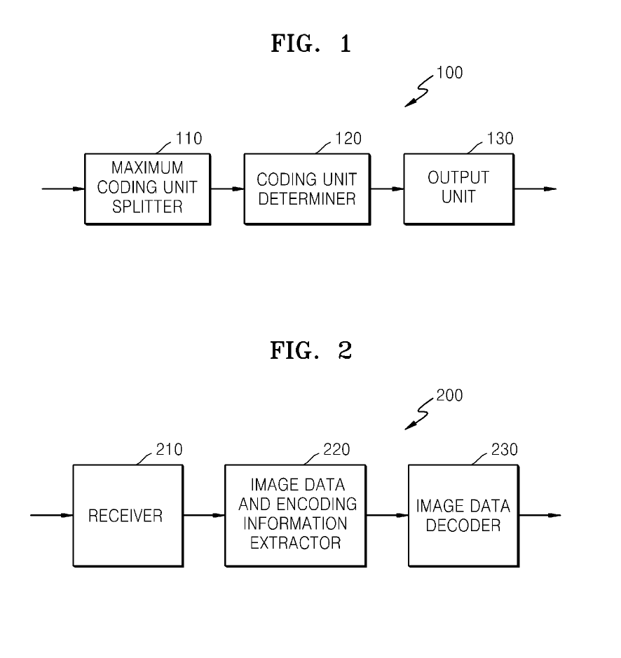

FIG. 1 is a block diagram of a video encoding apparatus 100 according to an exemplary embodiment.

The video encoding apparatus 100 includes a maximum coding unit splitter 110, a coding unit determiner 120, and an output unit 130.

The maximum coding unit splitter 110 may split a current picture based on a maximum coding unit for the current picture of an image. If the current picture is larger than the maximum coding unit, image data of the current picture may be split into the at least one maximum coding unit. The maximum coding unit according to an exemplary embodiment may be a data unit having a size of 32×32, 64×64, 128×128, 256×256, etc., wherein a shape of the data unit is a square having a width and length in squares of 2. The image data may be output to the coding unit determiner 120 according to the at least one maximum coding unit.

A coding unit according to an exemplary embodiment may be characterized by a maximum size and a depth. The depth denotes a number of times the coding unit is spatially split from the maximum coding unit, and as the depth increases, deeper coding units according to depths may be split from the maximum coding unit to a minimum coding unit. A depth of the maximum coding unit is an uppermost depth and a depth of the minimum coding unit is a lowermost depth. Since a size of a coding unit corresponding to each depth decreases as the depth of the maximum coding unit increases, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Since the maximum coding unit according to an exemplary embodiment is split according to depths, the image data of a spatial domain included in the maximum coding unit may be hierarchically classified according to depths.

A maximum depth and a maximum size of a coding unit, which limit the total number of times a height and a width of the maximum coding unit are hierarchically split may be predetermined.

The coding unit determiner 120 encodes at least one split region obtained by splitting a region of the maximum coding unit according to depths, and determines a depth to output finally encoded image data according to the at least one split region. In other words, the coding unit determiner 120 determines a coded depth by encoding the image data in the deeper coding units according to depths, according to the maximum coding unit of the current picture, and selecting a depth having the least encoding error. Thus, the encoded image data of the coding unit corresponding to the determined coded depth is finally output. Also, the coding units corresponding to the coded depth may be regarded as encoded coding units. The determined coded depth and the encoded image data according to the determined coded depth are output to the output unit 130.

The image data in the maximum coding unit is encoded based on the deeper coding units corresponding to at least one depth equal to or smaller than the maximum depth, and results of encoding the image data are compared based on each of the deeper coding units. A depth having the least encoding error may be selected after comparing encoding errors of the deeper coding units. At least one coded depth may be selected for each maximum coding unit.

The size of the maximum coding unit is split as a coding unit is hierarchically split according to depths, and as the number of coding units increases. Also, even if coding units correspond to a same depth in one maximum coding unit, it is determined whether to split each of the coding units corresponding to the same depth to a lower depth by measuring an encoding error of the image data of the each coding unit, separately. Accordingly, even when image data is included in one maximum coding unit, the image data is split into regions according to the depths and the encoding errors may differ according to regions in the one maximum coding unit, and thus the coded depths may differ according to regions in the image data. Thus, one or more coded depths may be determined in one maximum coding unit, and the image data of the maximum coding unit may be divided according to coding units of at least one coded depth.

Accordingly, the coding unit determiner 120 may determine coding units having a tree structure included in the maximum coding unit. The ‘coding units having a tree structure’ according to an exemplary embodiment include coding units corresponding to a depth determined to be the coded depth, from among all deeper coding units included in the maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth according to an exemplary embodiment is an index related to the number of times splitting is performed from a maximum coding unit to a minimum coding unit. A first maximum depth according to an exemplary embodiment may denote the total number of times splitting is performed from the maximum coding unit to the minimum coding unit. A second maximum depth according to an exemplary embodiment may denote the total number of depth levels from the maximum coding unit to the minimum coding unit. For example, when a depth of the maximum coding unit is 0, a depth of a coding unit, in which the maximum coding unit is split once, may be set to 1, and a depth of a coding unit, in which the maximum coding unit is split twice, may be set to 2. Here, if the minimum coding unit is a coding unit in which the maximum coding unit is split four times, 5 depth levels of depths 0, 1, 2, 3 and 4 exist, and thus the first maximum depth may be set to 4, and the second maximum depth may be set to 5.

Prediction encoding and transformation may be performed according to the maximum coding unit. The prediction encoding and the transformation are also performed based on the deeper coding units according to a depth equal to or depths less than the maximum depth, according to the maximum coding unit. Transformation may be performed according to a method of orthogonal transformation or integer transformation.

Since the number of deeper coding units increases whenever the maximum coding unit is split according to depths, encoding including the prediction encoding and the transformation is performed on all of the deeper coding units generated as the depth increases. For convenience of description, the prediction encoding and the transformation will now be described based on a coding unit of a current depth, in a maximum coding unit.

The video encoding apparatus 100 may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the maximum coding unit, the prediction encoding may be performed based on a coding unit corresponding to a coded depth, i.e., based on a coding unit that is no longer split into coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit or a data unit obtained by splitting at least one of a height and a width of the prediction unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 may also perform the transformation on the image data in a coding unit based not only on the coding unit for encoding the image data, but also based on a data unit that is different from the coding unit.

In order to perform the transformation in the coding unit, the transformation may be performed based on a data unit having a size smaller than or equal to the coding unit. For example, the data unit for the transformation may include a data unit for an intra mode and a data unit for an inter mode.

A data unit used as a base of the transformation will now be referred to as a ‘transformation unit’. Similarly to the coding unit, the transformation unit in the coding unit may be recursively split into smaller sized regions, so that the transformation unit may be determined independently in units of regions. Thus, residual data in the coding unit may be divided according to the transformation unit having the tree structure according to transformation depths.

A transformation depth indicating the number of times splitting is performed to reach the transformation unit by splitting the height and width of the coding unit may also be set in the transformation unit. For example, in a current coding unit of 2N×2N, a transformation depth may be 0 when the size of a transformation unit is 2N×2N, may be 1 when the size of a transformation unit is N×N, and may be 2 when the size of a transformation unit is N/2×N/2. That is, the transformation unit having the tree structure may also be set according to transformation depths.

Encoding information according to coding units corresponding to a coded depth requires not only information about the coded depth, but also about information related to prediction encoding and transformation. Accordingly, the coding unit determiner 120 not only determines a coded depth having a least encoding error, but also determines a partition type in a prediction unit, a prediction mode according to prediction units, and a size of a transformation unit for transformation.

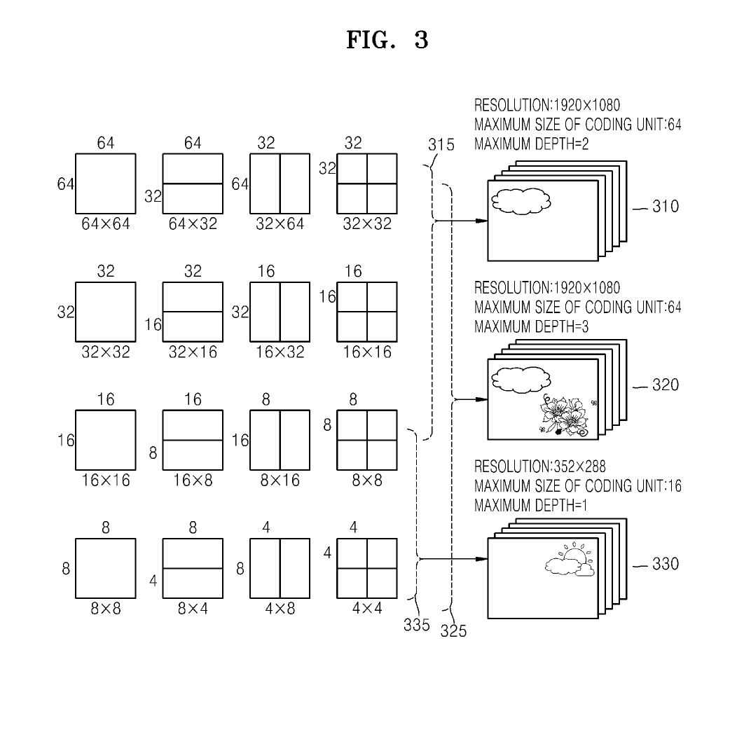

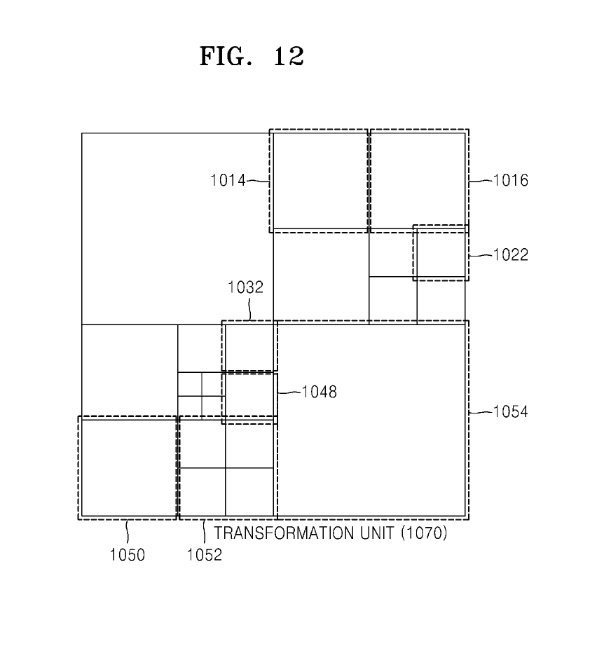

Coding units having a tree structure in a maximum coding unit and a method of determining a partition, according to exemplary embodiments, will be described in detail later with reference to FIGS. 3 through 12.

The coding unit determiner 120 may measure an encoding error of deeper coding units according to depths by using Rate-Distortion (RD) Optimization based on Lagrangian multipliers.

The output unit 130 outputs the image data of the maximum coding unit, which is encoded based on the at least one coded depth determined by the coding unit determiner 120, and information about the encoding mode according to the coded depth, in bitstreams.

The encoded image data may be obtained by encoding residual data of an image.

The information about the encoding mode according to coded depth may include information about the coded depth, about the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, image data in the current coding unit is encoded and output, and thus the split information may be defined not to split the current coding unit to a lower depth. Alternatively, if the current depth of the current coding unit is not the coded depth, the encoding is performed on the coding unit of the lower depth, and thus the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one maximum coding unit, and information about at least one encoding mode is determined for a coding unit of a coded depth, information about at least one encoding mode may be determined for one maximum coding unit. Also, a coded depth of the image data of the maximum coding unit may be different according to locations since the image data is hierarchically split according to depths, and thus information about the coded depth and the encoding mode may be set for the image data.

Accordingly, the output unit 130 may assign encoding information about a corresponding coded depth and an encoding mode to at least one of the coding unit, the prediction unit, and a minimum unit included in the maximum coding unit.

The minimum unit according to an exemplary embodiment is a rectangular data unit obtained by splitting the minimum coding unit constituting the lowermost depth by 4. Alternatively, the minimum unit may be a maximum rectangular data unit that may be included in all of the coding units, prediction units, partition units, and transformation units included in the maximum coding unit.

For example, the encoding information output through the output unit 130 may be classified into encoding information according to coding units, and encoding information according to prediction units. The encoding information according to the coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode. Also, information about a maximum size of the coding unit defined according to pictures, slices, or GOPs, and information about a maximum depth may be inserted into a header of a bitstream.

In the video encoding apparatus 100, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit of the current depth having the size of 2N×2N may include a maximum number of 4 coding units of the lower depth.

Accordingly, the video encoding apparatus 100 may form the coding units having the tree structure by determining coding units having an optimum shape and an optimum size for each maximum coding unit, based on the size of the maximum coding unit and the maximum depth determined considering characteristics of the current picture. Also, since encoding may be performed on each maximum coding unit by using any one of various prediction modes and transformations, an optimum encoding mode may be determined considering characteristics of the coding unit of various image sizes.

Thus, if an image having high resolution or a large data amount is encoded in a related art macroblock, a number of macroblocks per picture excessively increases. Accordingly, a number of pieces of compressed information generated for each macroblock increases, and thus it is difficult to transmit the compressed information and data compression efficiency decreases. However, by using the video encoding apparatus 100, image compression efficiency may be increased since a coding unit is adjusted while considering characteristics of an image while increasing a maximum size of a coding unit while considering a size of the image.

FIG. 2 is a block diagram of a video decoding apparatus 200, according to an exemplary embodiment.

The video decoding apparatus 200 includes a receiver 210, an image data and encoding information extractor 220, and an image data decoder 230. Definitions of various terms, such as a coding unit, a depth, a prediction unit, a transformation unit, and information about various encoding modes, for various operations of the video decoding apparatus 200 are identical to those described with reference to FIG. 1 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each maximum coding unit, and outputs the extracted image data to the image data decoder 230. The image data and encoding information extractor 220 may extract information about a maximum size of a coding unit of a current picture, from a header about the current picture.

Also, the image data and encoding information extractor 220 extracts information about a coded depth and an encoding mode for the coding units having a tree structure according to each maximum coding unit, from the parsed bitstream. The extracted information about the coded depth and the encoding mode is output to the image data decoder 230. In other words, the image data in a bit stream is split into the maximum coding unit so that the image data decoder 230 decodes the image data for each maximum coding unit.

The information about the coded depth and the encoding mode according to the maximum coding unit may be set for information about at least one coding unit corresponding to the coded depth, and information about an encoding mode may include information about a partition type of a corresponding coding unit corresponding to the coded depth, about a prediction mode, and a size of a transformation unit. Also, splitting information according to depths may be extracted as the information about the coded depth.

The information about the coded depth and the encoding mode according to each maximum coding unit extracted by the image data and encoding information extractor 220 is information about a coded depth and an encoding mode determined to generate a minimum encoding error when an encoder, such as the video encoding apparatus 100, repeatedly performs encoding for each deeper coding unit according to depths according to each maximum coding unit. Accordingly, the video decoding apparatus 200 may restore an image by decoding the image data according to a coded depth and an encoding mode that generates the minimum encoding error.

Since encoding information about the coded depth and the encoding mode may be assigned to a predetermined data unit from among a corresponding coding unit, a prediction unit, and a minimum unit, the image data and encoding information extractor 220 may extract the information about the coded depth and the encoding mode according to the predetermined data units. The predetermined data units to which the same information about the coded depth and the encoding mode is assigned may be inferred to be the data units included in the same maximum coding unit.

The image data decoder 230 restores the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transformation unit for each coding unit from among the coding units having the tree structure included in each maximum coding unit. A decoding process may include prediction including intra prediction and motion compensation, and inverse transformation. Inverse transformation may be performed according to a method of inverse orthogonal transformation or inverse integer transformation.

The image data decoder 230 may perform intra prediction or motion compensation according to a partition and a prediction mode of each coding unit, based on the information about the partition type and the prediction mode of the prediction unit of the coding unit according to coded depths.

Also, the image data decoder 230 may perform inverse transformation according to each transformation unit in the coding unit, based on the information about the size of the transformation unit of the coding unit according to coded depths, so as to perform the inverse transformation according to maximum coding units.

The image data decoder 230 may determine at least one coded depth of a current maximum coding unit by using split information according to depths. If the split information indicates that image data is no longer split in the current depth, the current depth is a coded depth. Accordingly, the image data decoder 230 may decode encoded data of at least one coding unit corresponding to the each coded depth in the current maximum coding unit by using the information about the partition type of the prediction unit, the prediction mode, and the size of the transformation unit for each coding unit corresponding to the coded depth, and output the image data of the current maximum coding unit.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode.

The video decoding apparatus 200 may obtain information about at least one coding unit that generates the minimum encoding error when encoding is recursively performed for each maximum coding unit, and may use the information to decode the current picture. In other words, the coding units having the tree structure determined to be the optimum coding units in each maximum coding unit may be decoded. Also, the maximum size of coding unit is determined considering resolution and an amount of image data.

Accordingly, even if image data has high resolution and a large amount of data, the image data may be efficiently decoded and restored by using a size of a coding unit and an encoding mode, which are adaptively determined according to characteristics of the image data, by using information about an optimum encoding mode received from an encoder.

A method of determining coding units having a tree structure, a prediction unit, and a transformation unit, according to an exemplary embodiment, will now be described with reference to FIGS. 3 through 13.

FIG. 3 is a diagram for describing a concept of coding units according to an exemplary embodiment.

A size of a coding unit may be expressed in width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 3 denotes a total number of splits from a maximum coding unit to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having the higher resolution than the video data 330 may be 64.

Since the maximum depth of the video data 310 is 2, coding units 315 of the vide data 310 may include a maximum coding unit having a long axis size of 64 and coding units having long axis sizes of 32 and 16 since depths are deepened to two layers by splitting the maximum coding unit twice. Meanwhile, since the maximum depth of the video data 330 is 1, coding units 335 of the video data 330 may include a maximum coding unit having a long axis size of 16, and coding units having a long axis size of 8 since depths are deepened to one layer by splitting the maximum coding unit once.

Since the maximum depth of the video data 320 is 3, coding units 325 of the video data 320 may include a maximum coding unit having a long axis size of 64 and coding units having long axis sizes of 32, 16, and 8 since the depths are deepened to 3 layers by splitting the maximum coding unit three times. As a depth increases, detailed information may be precisely expressed.

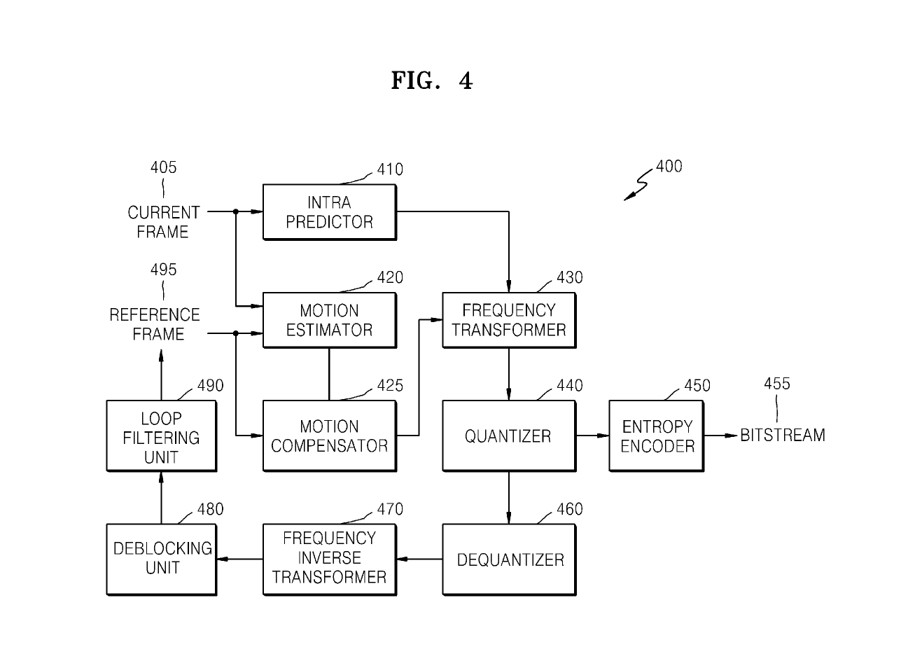

FIG. 4 is a block diagram of an image encoder 400 based on coding units, according to an exemplary embodiment.

The image encoder 400 performs operations of the coding unit determiner 120 of the video encoding apparatus 100 to encode image data. In other words, an intra predictor 410 performs intra prediction on coding units in an intra mode, from among a current frame 405, and a motion estimator 420 and a motion compensator 425 performs inter estimation and motion compensation on coding units in an inter mode from among the current frame 405 by using the current frame 405, and a reference frame 495.

Data output from the intra predictor 410, the motion estimator 420, and the motion compensator 425 is output as a quantized transformation coefficient through a transformer 430 and a quantizer 440. The quantized transformation coefficient is restored as data in a spatial domain through an inverse quantizer 460 and an inverse transformer 470, and the restored data in the spatial domain is output as the reference frame 495 after being post-processed through a deblocking unit 480 and a loop filtering unit 490. The quantized transformation coefficient may be output as a bitstream 455 through an entropy encoder 450.

In order for the image encoder 400 to be applied in the video encoding apparatus 100, all elements of the image encoder 400, i.e., the intra predictor 410, the motion estimator 420, the motion compensator 425, the transformer 430, the quantizer 440, the entropy encoder 450, the inverse quantizer 460, the inverse transformer 470, the deblocking unit 480, and the loop filtering unit 490 perform operations based on each coding unit from among coding units having a tree structure while considering the maximum depth of each maximum coding unit.

Specifically, the intra predictor 410, the motion estimator 420, and the motion compensator 425 determines partitions and a prediction mode of each coding unit from among the coding units having a tree structure while considering the maximum size and the maximum depth of a current maximum coding unit, and the transformer 430 determines the size of the transformation unit in each coding unit from among the coding units having a tree structure.

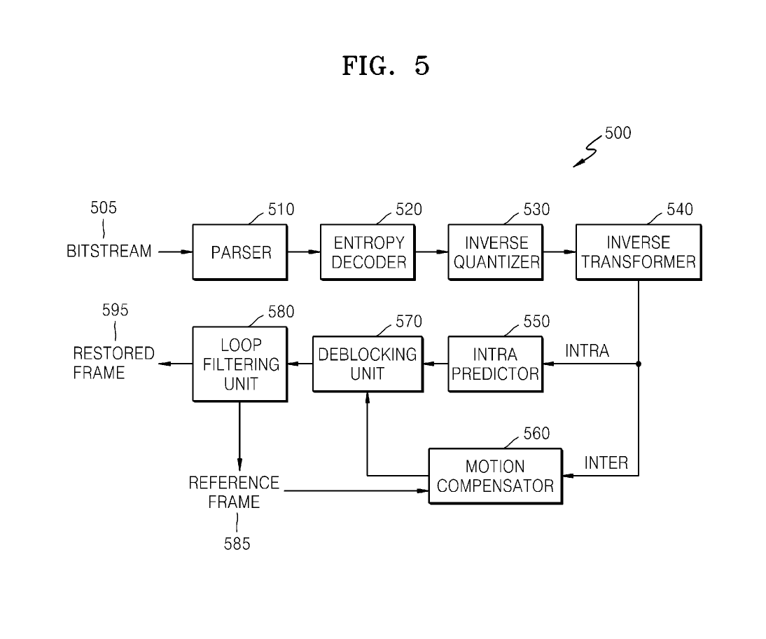

FIG. 5 is a block diagram of an image decoder 500 based on coding units, according to an exemplary embodiment.

A parser 510 parses encoded image data to be decoded and information about encoding required for decoding from a bitstream 505. The encoded image data is output as inverse quantized data through an entropy decoder 520 and an inverse quantizer 530, and the inverse quantized data is restored to image data in a spatial domain through an inverse transformer 540.

An intra predictor 550 performs intra prediction on coding units in an intra mode with respect to the image data in the spatial domain, and a motion compensator 560 performs motion compensation on coding units in an inter mode by using a reference frame 585.

The image data in the spatial domain, which passed through the intra predictor 550 and the motion compensator 560, may be output as a restored frame 595 after being post-processed through a deblocking unit 570 and a loop filtering unit 580. Also, the image data, which is post-processed through the deblocking unit 570 and the loop filtering unit 580, may be output as the reference frame 585.

In order to decode the image data in the image data decoder 230 of the video decoding apparatus 200, the image decoder 500 may perform operations that are performed after operations of the parser 510 are performed.

In order for the image decoder 500 to be applied in the video decoding apparatus 200, all elements of the image decoder 500, i.e., the parser 510, the entropy decoder 520, the inverse quantizer 530, the inverse transformer 540, the intra predictor 550, the motion compensator 560, the deblocking unit 570, and the loop filtering unit 580 perform operations based on coding units having a tree structure for each maximum coding unit.

Specifically, the intra predictor 550 and the motion compensator 560 perform operations based on partitions and a prediction mode for each of the coding units having a tree structure, and the inverse transformer 540 perform operations based on a size of a transformation unit for each coding unit.

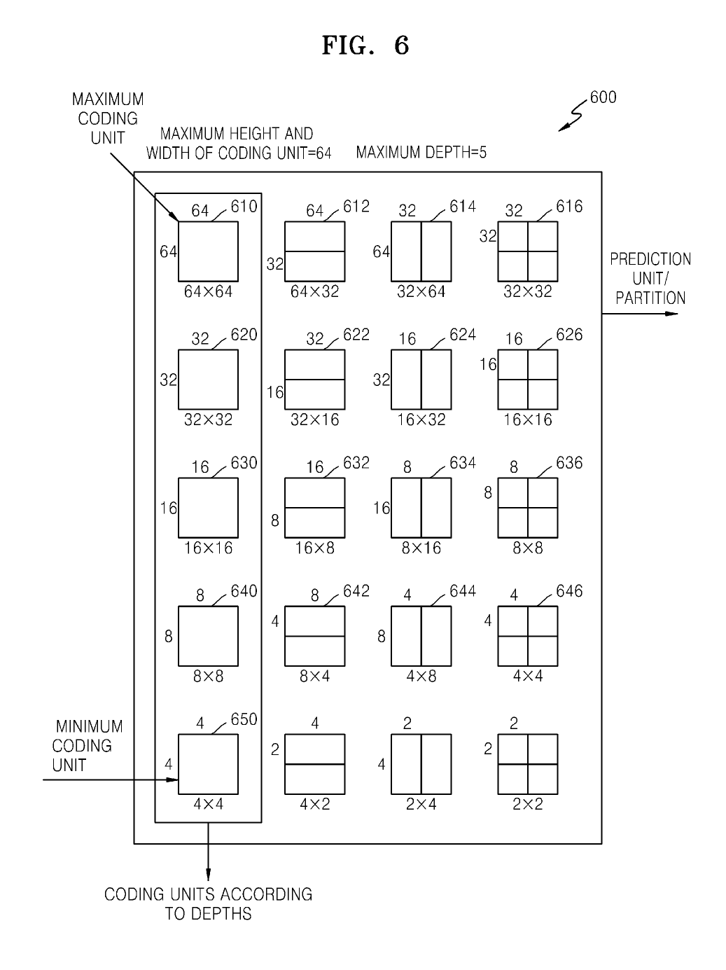

FIG. 6 is a diagram illustrating deeper coding units according to depths, and partitions, according to an exemplary embodiment.

The video encoding apparatus 100 and the video decoding apparatus 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units, according to an exemplary embodiment, the maximum height and the maximum width of the coding units are each 64, and the maximum depth is 4. Since a depth increases along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a maximum coding unit in the hierarchical structure 600, wherein a depth is 0 and a size, i.e., a height by width, is 64×64. The depth increases along the vertical axis, and a coding unit 620 having a size of 32×32 and a depth of 1, a coding unit 630 having a size of 16×16 and a depth of 2, a coding unit 640 having a size of 8×8 and a depth of 3, and a coding unit 650 having a size of 4×4 and a depth of 4 exist. The coding unit 650 having the size of 4×4 and the depth of 4 is a minimum coding unit.

The prediction unit and the partitions of a coding unit are arranged along the horizontal axis according to each depth. In other words, if the coding unit 610 having the size of 64×64 and the depth of 0 is a prediction unit, the prediction unit may be split into partitions include in the coding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

The coding unit 650 having the size of 4×4 and the depth of 4 is the minimum coding unit and a coding unit of the lowermost depth. A prediction unit of the coding unit 650 is only assigned to a partition having a size of 4×4.

In order to determine the at least one coded depth of the coding units constituting the maximum coding unit 610, the coding unit determiner 120 of the video encoding apparatus 100 performs encoding for coding units corresponding to each depth included in the maximum coding unit 610.

A number of deeper coding units according to depths including data in the same range and the same size increases as the depth increases. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths and performing encoding for each depth as the depth increases along the vertical axis of the hierarchical structure 600. A depth and a partition having the minimum encoding error in the coding unit 610 may be selected as the coded depth and a partition type of the coding unit 610.

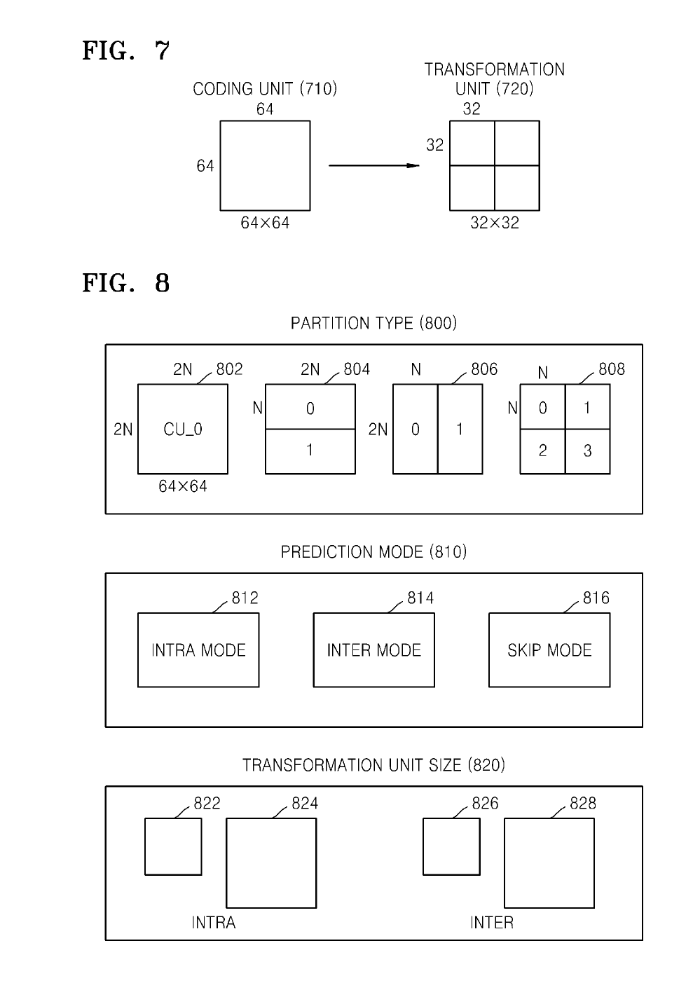

FIG. 7 is a diagram for describing a relationship between a coding unit 710 and transformation units 720, according to an exemplary embodiment.

The video encoding apparatus 100 or the video decoding apparatus 200 encodes or decodes an image according to coding units having sizes smaller than or equal to a maximum coding unit for each maximum coding unit. Sizes of transformation units for transformation during encoding may be selected based on data units that are not larger than a corresponding coding unit.

For example, in the video encoding apparatus 100 or the video decoding apparatus 200, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

FIG. 8 is a diagram for describing encoding information of coding units corresponding to a coded depth, according to an exemplary embodiment.

The output unit 130 of the video encoding apparatus 100 may encode and transmit information 800 about a partition type, information 810 about a prediction mode, and information 820 about a size of a transformation unit for each coding unit corresponding to a coded depth, as information about an encoding mode.

The information 800 indicates information about a shape of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second intra transformation unit 828.

The image data and encoding information extractor 220 of the video decoding apparatus 200 may extract and use the information 800, 810, and 820 for decoding, according to each deeper coding unit

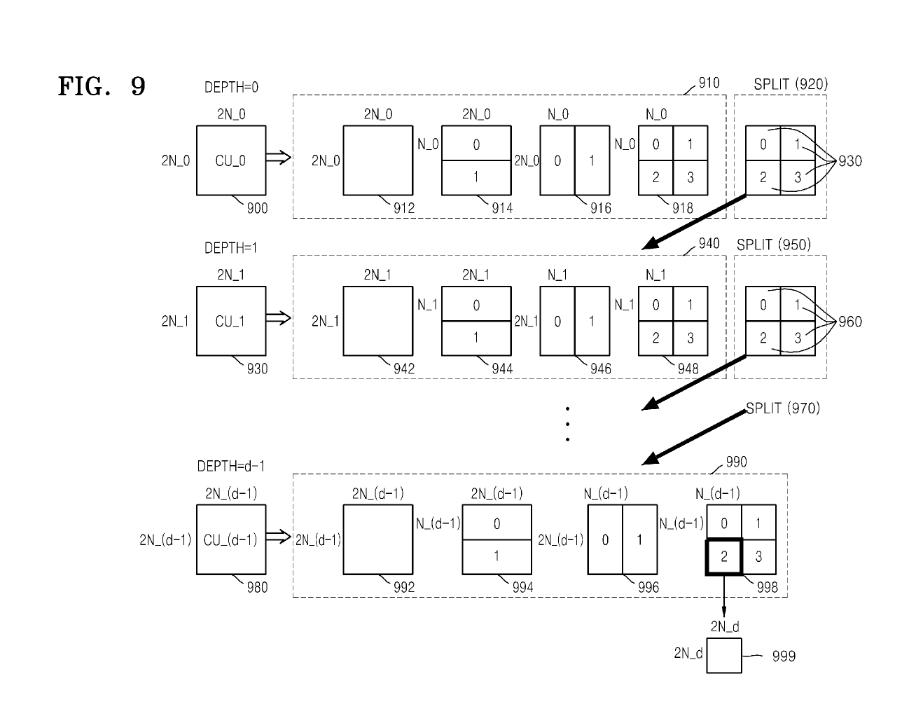

FIG. 9 is a diagram of deeper coding units according to depths, according to an exemplary embodiment.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode is performed only on the partition having the size of 2N_{—}0×2N_{—}0.

If an encoding error is smallest in one of the partition types 912 through 916 having the sizes of 2N_{—}0×2N_{—}0, 2N_{—}0×N_{—}0, and N_{—}0×2N_{—}0, the prediction unit 910 may not be split into a lower depth.

If the encoding error is the smallest in the partition type 918 having the size of N_{—}0×N_{—}0, a depth is changed from 0 to 1 to split the partition type 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948 having the size of N_{—}1×N_{—}1, a depth is changed from 1 to 2 to split the partition type 948 in operation 950, and encoding is repeatedly performed on coding units 960, which have a depth of 2 and a size of N_{—}2×N_{—}2 to search for a minimum encoding error.

When a maximum depth is d, split operation according to each depth may be performed up to when a depth becomes d-1, and split information may be encoded as up to when a depth is one of 0 to d-2. In other words, when encoding is performed up to when the depth is d-1 after a coding unit corresponding to a depth of d-2 is split in operation 970, a prediction unit 990 for prediction encoding a coding unit 980 having a depth of d-1 and a size of 2N_(d-1)×2N_(d-1) may include partitions of a partition type 992 having a size of 2N_(d-1)×2N_(d-1), a partition type 994 having a size of 2N_(d-1)×N_(d-1), a partition type 996 having a size of N_(d-1)×2N_(d-1), and a partition type 998 having a size of N_(d-1)×N_(d-1).

Prediction encoding may be repeatedly performed on one partition having a size of 2N_(d-1)×2N_(d-1), two partitions having a size of 2N_(d-1)×N_(d-1), two partitions having a size of N_(d-1)×2N_(d-1), four partitions having a size of N_(d-1)×N_(d-1) from among the partition types 992 through 998 to search for a partition type having a minimum encoding error.

Even when the partition type 998 having the size of N_(d-1)×N_(d-1) has the minimum encoding error, since a maximum depth is d, a coding unit CU_(d-1) having a depth of d-1 is no longer split to a lower depth, and a coded depth for the coding units constituting a current maximum coding unit 900 is determined to be d-1 and a partition type of the current maximum coding unit 900 may be determined to be N_(d-1)×N_(d-1). Also, since the maximum depth is d and a minimum coding unit 980 having a lowermost depth of d-1 is no longer split to a lower depth, split information for the minimum coding unit 980 is not set.

A data unit 999 may be a ‘minimum unit’ for the current maximum coding unit. A minimum unit according to an exemplary embodiment may be a rectangular data unit obtained by splitting a minimum coding unit 980 by 4. By performing the encoding repeatedly, the video encoding apparatus 100 may select a depth having the least encoding error by comparing encoding errors according to depths of the coding unit 900 to determine a coded depth, and set a corresponding partition type and a prediction mode as an encoding mode of the coded depth.

As such, the minimum encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Also, since a coding unit is split from a depth of 0 to a coded depth, only split information of the coded depth is set to 0, and split information of depths excluding the coded depth is set to 1.

The image data and encoding information extractor 220 of the video decoding apparatus 200 may extract and use the information about the coded depth and the prediction unit of the coding unit 900 to decode the partition 912. The video decoding apparatus 200 may determine a depth, in which split information is 0, as a coded depth by using split information according to depths, and use information about an encoding mode of the corresponding depth for decoding.

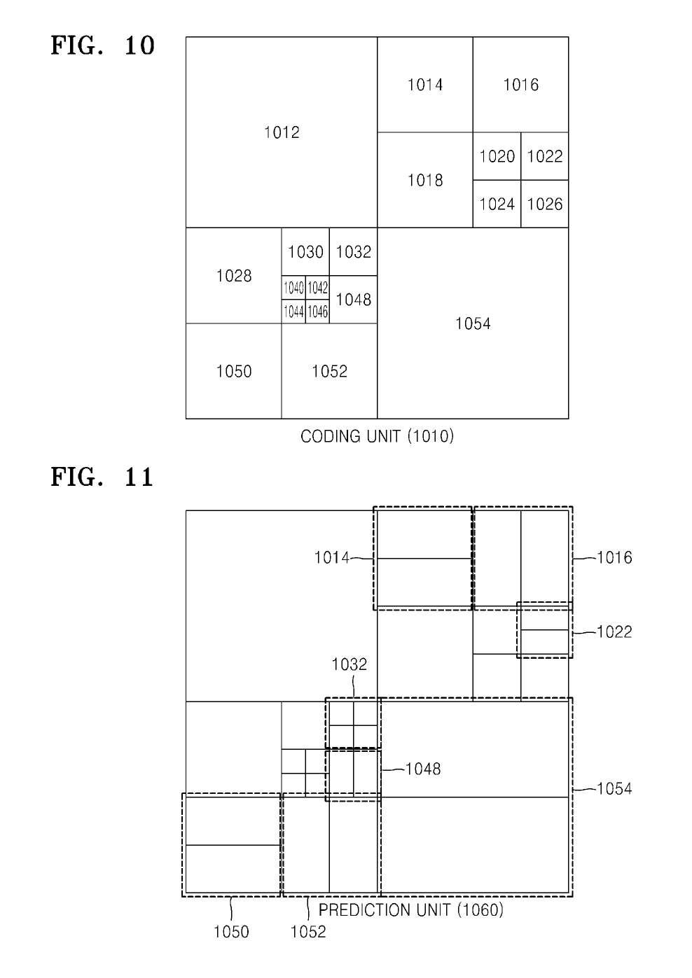

FIGS. 10 through 12 are diagrams for describing a relationship between coding units 1010, prediction units 1060, and transformation units 1070, according to an exemplary embodiment.

The coding units 1010 are coding units having a tree structure, corresponding to coded depths determined by the video encoding apparatus 100, in a maximum coding unit. The prediction units 1060 are partitions of prediction units of each of the coding units 1010, and the transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some coding units 1014, 1016, 1022, 1032, 1048, 1050, 1052, and 1054 are obtained by splitting the coding units. In other words, partition types in the coding units 1014, 1022, 1050, and 1054 have a size of 2N×N, partition types in the coding units 1016, 1048, and 1052 have a size of N×2N, and a partition type of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are different from those in the prediction units 1060 in terms of sizes and shapes. In other words, the video encoding and decoding apparatuses 100 and 200 may perform intra prediction, motion estimation, motion compensation, transformation, and inverse transformation individually on a data unit in the same coding unit.

Accordingly, encoding is recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit. Table 1 shows the encoding information that may be set by the video encoding and decoding apparatuses 100 and 200.

TABLE 1

| Split Information 0 | | | | | |
|---|---|---|---|---|---|
| (Encoding on Coding Unit having Size of | | | | | |
| 2Nx2N and Current Depth of d) | | | | | |
| Prediction | Partition | Size of | Split Information 1 | | |
| Mode | Type | Transformation Unit | Repeatedly Encode | | |
| Intra | Symmetrical | Asymmetrical | Split | Split | Coding |
| Inter | Partition | Partition | Information | Information | Units |
| | Type | Type | 0 of | 1 of | having |
| | | | Transformation | Transformation | Lower |
| | | | Unit | Unit | Depth of |
| Skip | 2Nx2N | 2NxnU | 2Nx2N | NxN | d + 1 |
| (Only | 2NxN | 2NxnD | | (Symmetrical | |
| 2Nx2N) | Nx2N | nLx2N | | Type) | |
| | NxN | nRx2N | | N/2xN/2 | |
| | | | | (Asymmetrical | |
| | | | | Type) | |

The output unit 130 of the video encoding apparatus 100 may output the encoding information about the coding units having a tree structure, and the image data and encoding information extractor 220 of the video decoding apparatus 200 may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a coded depth, and thus information about a partition type, prediction mode, and a size of a transformation unit may be defined for the coded depth. If the current coding unit is further split according to the split information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure may include at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth is determined by using encoding information of a data unit, and thus a distribution of coded depths in a maximum coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred to for predicting the current coding unit.

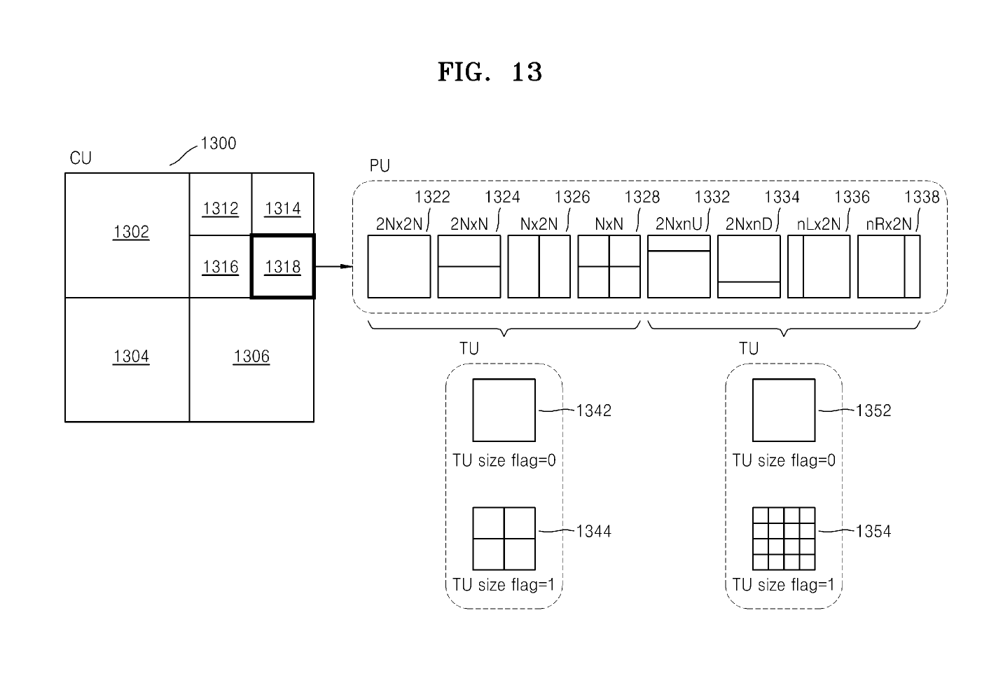

FIG. 13 is a diagram for describing a relationship between a coding unit, a prediction unit or a partition, and a transformation unit, according to the encoding mode information of Table 1.

A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

When the partition type is set to be symmetrical, i.e. the partition type 1322, 1324, 1326, or 1328, a transformation unit 1342 having a size of 2N×2N is set if split information (TU size flag) of a transformation unit is 0, and a transformation unit 1344 having a size of N×N is set if a TU size flag is 1.

When the partition type is set to be asymmetrical, i.e., the partition type 1332, 1334, 1336, or 1338, a transformation unit 1352 having a size of 2N×2N is set if a TU size flag is 0, and a transformation unit 1354 having a size of N/2×N/2 is set if a TU size flag is 1.

Methods and apparatuses for scalable video encoding and decoding according to exemplary embodiments will be now described in detail with reference to FIGS. 14 through 25 below.

FIG. 14 is a block diagram illustrating a scalable video encoding apparatus 1400 according to an exemplary embodiment.

The scalable video encoding apparatus 1400 includes a base layer encoder 1410, an enhancement layer encoder 1420, and an output unit 1430.

The scalable video encoding apparatus 1400 classifies an input video into a base layer and an enhancement layer, and encodes a video of the base layer and a video of the enhancement layer to generate a scalable bitstream and output the same. According to a scalable video encoding method, an input image may be classified into multilayer layer images according to not only the spatial characteristics such as a resolution but also the temporal characteristics or qualitative characteristics such as an image quality. Hereinafter, for convenience of description, an exemplary embodiment in which the scalable video encoding apparatus 1400 performs encoding by classifying a low resolution image as a base layer image and a high resolution image as an enhancement layer image according to an image resolution will be mainly described.

Spatial scalability is achieved by using a multilayer encoding method in which a video sequence having a small resolution and a video sequence having a high resolution are each individually encoded. For example, a bitstream of a base layer is obtained by encoding a video sequence having a QVGA resolution, and a bitstream of an enhancement layer may be obtained by encoding a video sequence having a high resolution such as a VGA or WVGA resolution. Hereinafter, a small-resolution video sequence will be defined as a base layer image, and a high-resolution video sequence will be defined as an enhancement layer image. A base layer image and an enhancement layer image may be individually encoded, or an encoding result of a base layer image may also be used in encoding of an enhancement layer image to increase an encoding efficiency.

Referring to FIG. 14, the base layer encoder 1410 encodes a base layer image. The base layer encoder 1410 may encode a base layer image based on coding units having a tree structure as described above with reference to FIGS. 1 through 13. That is, the base layer encoder 1410 may split a base layer image into maximum coding units, and also may determine an encoding mode of coding units in which the respective maximum coding units are hierarchically split.

The enhancement layer encoder 1420 encodes an enhancement layer image. The enhancement layer encoder 1420 may encode an enhancement layer image based on coding units having a tree structure described above with reference to FIGS. 1 through 13. Also, the enhancement layer encoder 1420 may encode an enhancement layer image by using a base layer image that is encoded by using the base layer encoder 1410 and then restored in intra prediction of the enhancement layer image.

The output unit 1430 may output encoding information related to a base layer image according to an encoding result of the base layer encoder 410. Also, the output unit 1430 may output encoding information related to an enhancement layer image according to an encoding result of the enhancement layer encoder 1420. Encoding information may include prediction mode information of a block constituting each base layer image and an enhancement layer image and various encoding information. As will be described later, if the enhancement layer encoder 1420 intra prediction encodes an enhancement layer block by selectively referring to the restored base layer image, the output unit 1430 may include information about a reference pixel determination method of a current block in encoding information of the current block (explicit mode) or may skip information about a reference pixel determination method but include only flag information indicating whether a base layer block is used, in encoding information of an enhancement layer block (implicit mode).

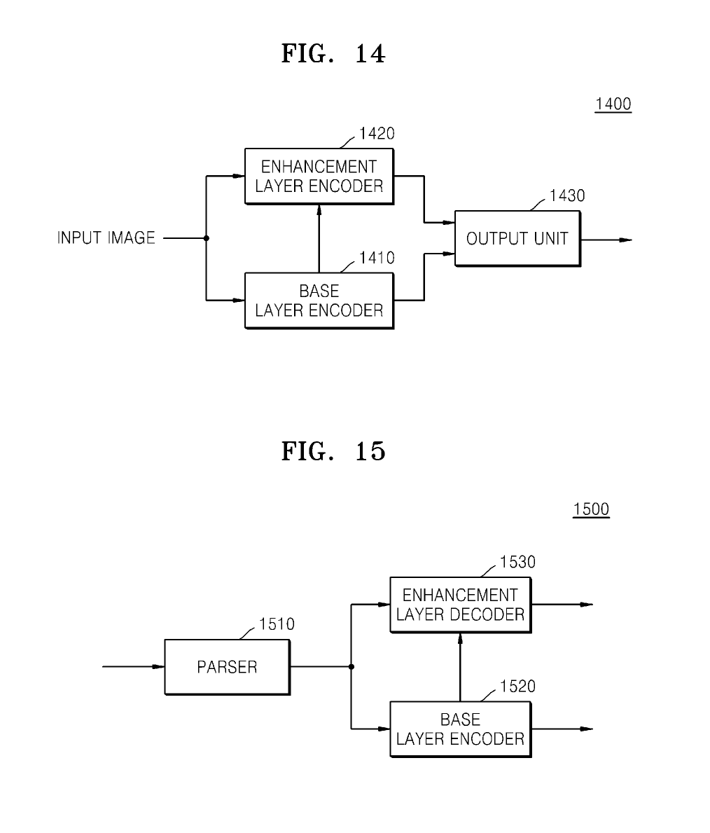

FIG. 15 is a block diagram illustrating a scalable video decoding apparatus 1500 according to an exemplary embodiment.

The scalable video decoding apparatus 1500 includes a parser 1510, a base layer decoder 1520, and an enhancement layer decoder 1530.

The parser 1510 parses encoding information of a base layer image and encoding information of an enhancement layer image from a received bitstream.

The base layer decoder 1520 decodes a base layer image based on encoding information of the base layer image. If the scalable video decoding apparatus 1500 uses coding units having a tree structure, the base layer decoding unit 1520 may determine a coding unit having a tree structure for each maximum coding unit having a tree structure and may generate a prediction value of each coding unit to thereby perform decoding for each maximum coding unit.

The enhancement layer decoder 1530 decodes an enhancement layer image based on encoding information of the enhancement layer image. The enhancement layer decoder 1530 may decode an enhancement layer image based on coding units having a tree structure as described above. Also, the enhancement layer decoder 1530 may intra prediction decode an enhancement layer block by selectively using, as a peripheral pixel, a restored base layer image that is previously restored when the base layer decoder 1520 intra predicts an enhancement layer image. A method of intra predicting an enhancement layer block by using a base layer image will be described later.

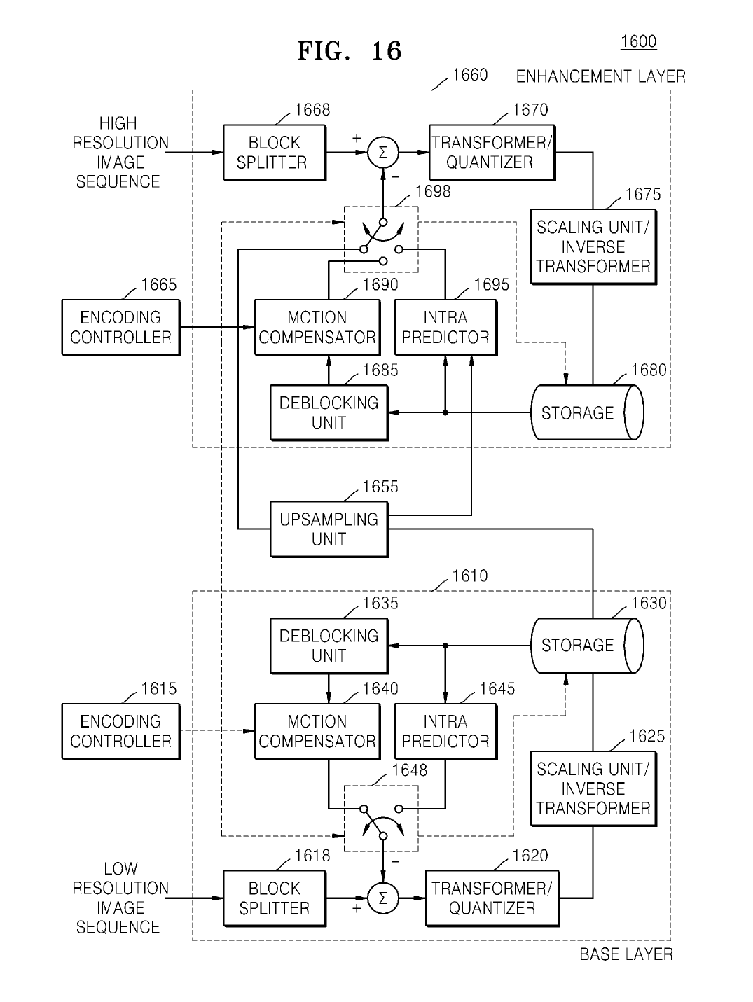

FIG. 16 is a detailed block diagram of a scalable encoding apparatus 1600 according to an exemplary embodiment.

The scalable encoding apparatus 1600 includes a base layer encoding apparatus 1610 and an enhancement layer encoding apparatus 1660. The base layer encoding apparatus 1610 and the enhancement layer encoding apparatus 1660 may respectively correspond to the base layer encoder 1410 and the enhancement layer encoder 1420 of FIG. 14.

First, the base layer encoding apparatus 1610 will be described.

A block splitter 1618 of a base layer splits a base layer image into blocks of a predetermined size. As described above, instead of using a block of a fixed size, the scalable encoding apparatus 1600 may use a coding unit having a tree structure, which is obtained by splitting an image based on a maximum coding unit. Hereinafter, for convenience of description, a coding unit will be referred to as a block.

Intra prediction or inter prediction may be performed on each block that is output from the block splitter 1618. A motion compensator 1640 may perform inter prediction on a current block to output a prediction block of the current block, and an intra predictor 1645 performs intra prediction on the current block to output a prediction block of the current block. An encoding controller 1615 may determine a prediction mode that is used in obtaining a prediction block that is most similar to the current block from among an intra prediction mode and an inter prediction mode, and may control a prediction switch 1648 such that a prediction block according to the determined prediction mode is output. A residual, which is a difference between a prediction block of a current block obtained by intra prediction or inter prediction and the current block, is converted and quantized by using a transformer/quantizer 1620 to output a quantized transformation coefficient. The scaling unit/inverse transformer 1625 performs scaling and inverse transformation on the quantized transformation coefficient to restore the residual. The storage 1630 restores the current block by adding the restored residual and the prediction block of the current block and stores the restored current block. Encoding of every block of the base layer image that is split by using the block splitter 1618 is performed, and blocks of the basis layer that is encoded and then restored are stored in the storage 1630. A deblocking unit 1635 performs deblocking filtering on the restored base layer image.

An upsampling unit 1655 upsamples a base layer image to output an upsampled image corresponding to an enhancement layer image.

Next, the enhancement layer encoding apparatus 1660 will be described in detail.

A block splitter 1668 of an enhancement layer splits an enhancement layer image into blocks of a predetermined size. Intra prediction or inter prediction may be performed on each block output from the block splitter 1668. A motion compensator 1690 performs inter prediction on a current block to output a prediction block of the current block, and an intra predictor 1695 performs intra prediction on the current block to output a prediction block of the current block.

In particular, the intra predictor 1695 of an enhancement layer according to the exemplary embodiment performs intra prediction on a current block of an enhancement layer by selectively using a peripheral pixel of the current block of the enhancement layer that is encoded and then restored before the current block of the enhancement layer and a peripheral pixel of an enhancement layer block that is obtained based on a peripheral pixel of a base layer block. Intra prediction on the current block of the enhancement layer will be described in detail later.

An encoding controller 1665 determines a prediction mode that is used in obtaining a prediction block that is most similar to the current block of the enhancement layer from among an intra prediction mode and an inter prediction mode, and controls a prediction switch 1698 such that a prediction block of a current block is output according to the determined prediction mode. A residual, which is a difference between the prediction block of the current block obtained through intra prediction or inter prediction and the current block, is transformed and quantized by using the transformer/quantizer 1670 that outputs a quantized transformation coefficient. The scaling unit/inverse quantizer 1675 performs scaling and inverse transformation on the quantized transformation coefficient to restore the residual. The storage 1680 restores the current block by adding the restored residual and the prediction block of the current block and stores the restored current block. A deblocking unit 1685 performs deblocking filtering on the restored enhancement layer image.

Hereinafter, inter layer intra prediction performed by using the intra predictor 1695 of an enhancement layer will be described in detail.

A method of determining a reference pixel of an enhancement layer may be classified into an explicit mode and an implicit mode according to a method in which at least one of a peripheral pixel of the restored enhancement layer current block and a peripheral pixel of a base layer block is selected as a reference pixel of intra prediction of a current block of an enhancement layer and according to whether the selected reference pixel determination method is included in encoding information of the enhancement layer block to be transmitted.

1) Explicit Mode

An explicit mode is a mode in which, when performing intra prediction on a current block of an enhancement layer, the current block of the enhancement layer is intra prediction encoded by using various reference pixel determination methods in which a peripheral pixel of the current block of the enhancement layer obtained by using a restored base layer image is selectively used, and a reference pixel determination method having a minimum cost is determined, and information about the determined reference pixel determination method is included in encoding information of the current block of the enhancement layer to be transmitted.

In detail, the intra predictor 1695 of an enhancement layer obtains a first prediction block of a current block of an enhancement layer based on a first reference pixel determination method in which only peripheral pixels of the current block of the enhancement layer, which is encoded before the current block of the enhancement layer and then restored, are used as a reference block. Also, the intra predictor 1695 of an enhancement layer obtains a second prediction block of the current block of the enhancement layer based on a second reference pixel determination method in which only peripheral pixels that are obtained based on a peripheral pixel of a base layer block corresponding to the current block of the enhancement layer are used as reference pixels. Also, the intra predictor 1695 of an enhancement layer obtains a third prediction block of the current block of the enhancement layer based on a third reference pixel determination method in which a peripheral pixel of an enhancement layer that is encoded before the current block of the enhancement layer and then restored and a peripheral pixel of the current block of the enhancement layer that is obtained based on a peripheral pixel of a base layer block both are used as a reference pixel. Also, the intra predictor 1695 may determine a reference pixel determination method used in obtaining a prediction block having a minimum cost by comparing costs of the first through third prediction blocks based on each reference pixel determination method and may include information about the determined reference pixel determination method in encoding information of the current block of the enhancement layer. Various evaluation functions such as sum of absolute difference (SAD), mean absolute difference (MAD), or mean square error (MSE) may be used in obtaining a cost.

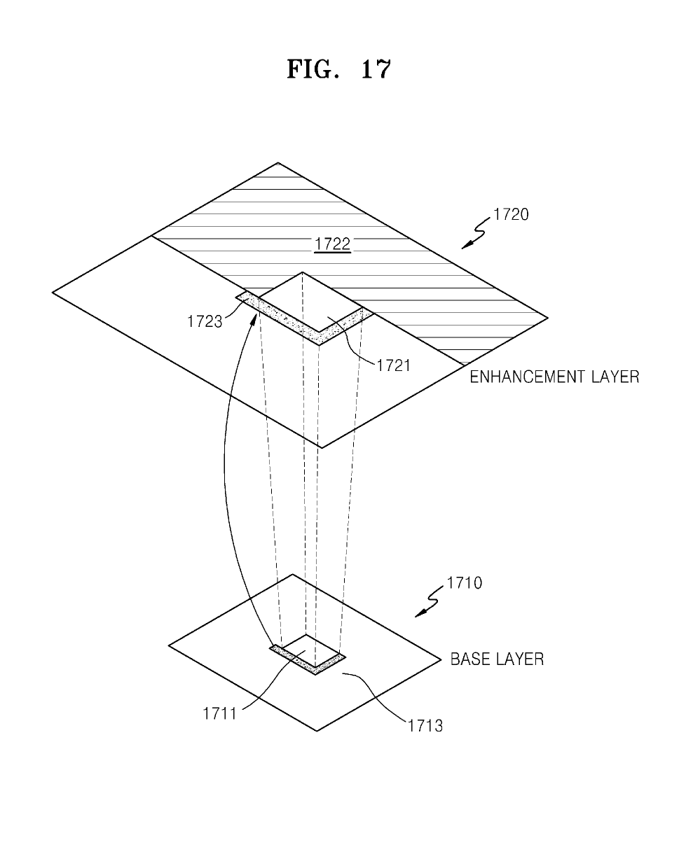

FIG. 17 illustrates a relationship between a block of a base layer corresponding to a current block of an enhancement layer and a peripheral pixel of the base layer corresponding to a peripheral pixel of the enhancement layer, according to an exemplary embodiment. A base layer image 1710 and an enhancement layer image 1720 corresponding to the base layer image 1710 are illustrated.

When encoding blocks of an enhancement layer in a predetermined scanning order such as in a raster scanning method, peripheral pixels 1722 located on upper side and left side of a current block 1721 of an enhancement layer may be encoded previously and then restored to be used as a reference pixel in intra prediction on the current block 1721 of the enhancement layer. However, peripheral pixels 1723 located on lower side and right side of the current block 1721 of the enhancement layer may not be used as a reference pixel for intra prediction. Accordingly, the intra predictor 1695 of an enhancement layer may obtain a reference pixel corresponding to the peripheral pixels 1723 under and to the right of the current block 1721 of the enhancement layer based on peripheral pixels 1713 of a base layer block 1711 corresponding to the current block 1721 of the enhancement layer.

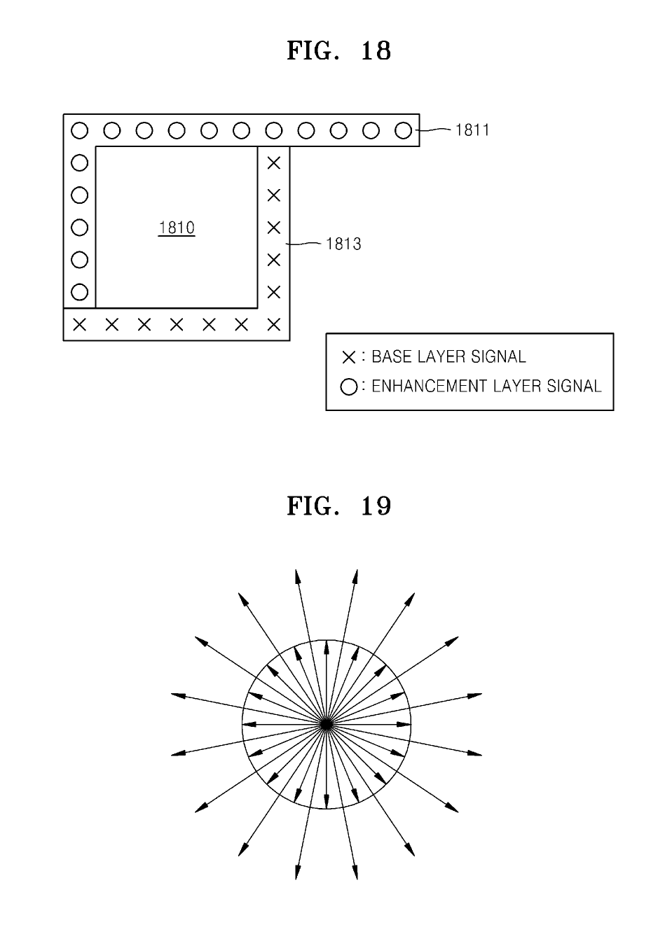

FIG. 18 illustrates a relationship between a peripheral pixel of an enhancement layer used in a current block of an enhancement layer and a peripheral pixel of the enhancement layer obtained from a base layer image, according to an exemplary embodiment.

Referring to FIG. 18, the intra predictor 1695 of an enhancement layer may perform intra prediction on a current block 1810 of an enhancement layer by using as a reference pixel at least one of peripheral pixels 1811 of the enhancement layer that are encoded previously and then restored and peripheral pixels 1813 that are obtained from a restored base layer image.

The intra predictor 1695 of an enhancement layer obtains a first prediction block of the current block of the enhancement layer based on a first reference pixel determination method in which only peripheral pixels 1811 of the current block of the enhancement layer that is encoded before the current block 1810 of the enhancement layer and then restored are used as a reference pixel. In detail, the intra predictor 1695 of an enhancement layer obtains a first prediction block of the current block 1810 of the enhancement layer by obtaining prediction blocks of the current block 1810 by applying intra prediction modes in which only the peripheral blocks 1811 of the current block of the enhancement layer that are encoded before and restored are used, from among intra prediction modes having various directivities, and by obtaining a prediction block having a minimum cost.

Also, the intra predictor 1695 of an enhancement layer obtains a second prediction block of the current block of the enhancement layer based on a second reference pixel determination method in which only peripheral pixels 1813 that are obtained based on a peripheral pixel of a base layer block are used as a reference pixel. In detail, the intra predictor 1695 of an enhancement layer obtains a second prediction block of the current block 1810 of the enhancement layer by obtaining prediction blocks of the current block 1810 by applying intra prediction modes in which only the peripheral blocks 1813 of the current block of the enhancement layer that are obtained based on a peripheral pixel of a base layer block are used, from among intra prediction modes having various directivities, and by obtaining a prediction block having a minimum cost.

Also, the intra predictor 1695 of an enhancement layer obtains a third prediction block of the current block of the enhancement layer based on a third reference pixel determination method in which both the peripheral pixels 1811 of the enhancement layer that is encoded before and then restored and the peripheral pixels 1813 that are obtained based on a peripheral pixel of a base layer block are used as a reference pixel. According to the third reference pixel determination method, as all peripheral pixels of the current block 1810 are available, a prediction block of the current block 1810 may be obtained by applying an intra prediction mode having even more various directivities.

As described above, when the first through third prediction blocks are obtained according to the reference pixel determination methods in which peripheral pixels obtained from a base layer image are selectively used, the intra predictor 1695 determines a reference pixel determination method used in obtaining a prediction block having a minimum cost by comparing costs of the first through third prediction blocks. Information about the determined reference pixel determination method may be included in encoding information of the current block of the enhancement layer. For example, assuming that a syntax regarding a reference pixel determination method is interlayer_intraprediction_ref_mode, when interlayer_intraprediction_ref_mode is 0, only a reference pixel of an enhancement layer is used in intra prediction of an enhancement layer block according to the first reference pixel determination method, when interlayer_intraprediction_ref_mode is 1, it is indicated that only a peripheral pixel obtained from a base layer image is used in intra prediction of an enhancement layer block according to the second reference pixel determination method, and when interlayer_intraprediction_ref_mode is 2, it is indicated that both a peripheral pixel of an enhancement layer and a peripheral pixel obtained from a base layer are used as a reference pixel for intra prediction of an enhancement layer block. In addition to syntax information about a reference pixel determination method (interlayer_intraprediction_ref_mode), intra prediction mode information indicating a direction of intra prediction that is finally determined may be included as encoding information about a current block of an enhancement layer.

In an explicit mode, instead of including syntax information about the first through third reference pixel determination methods, a flag indicating whether a peripheral pixel obtained from a base layer is used in intra prediction of a current block of an enhancement layer is used and finally determined intra prediction mode information may be included in encoding information of the current block of the enhancement layer. When performing intra prediction on a current block of an enhancement layer, assuming that a flag indicating whether a peripheral pixel obtained from a base layer is used in intra prediction of a current block of an enhancement layer is enable_interlayer_intraprediction_flag, and when enable_interlayer_intraprediction_flag is 0, this may indicate that only a peripheral pixel of an enhancement layer is used in intra prediction of an enhancement layer block according to the first reference pixel determination method. If enable_interlayerintraprediction_flag is 1 and an intra prediction mode of an enhancement layer block indicates an unavailable peripheral pixel of an enhancement layer, this may indicate that only a peripheral pixel of an enhancement layer is used in intra prediction of an enhancement layer block according to the second reference pixel determination method. If enable_interlayerintraprediction_flag is 1 and an intra prediction mode of an enhancement layer block indicates both available peripheral pixel of an enhancement layer and unavailable peripheral pixel of an enhancement layer, this may indicate only a peripheral pixel of an enhancement layer is used in intra prediction of an enhancement layer block according to the third reference pixel determination method.

FIG. 19 illustrates an intra prediction mode used in intra prediction of a base layer image and an enhancement layer image, according to an exemplary embodiment.

If a peripheral pixel to be used for a current block of an enhancement layer is determined according to one of the first through third reference pixel determination methods, the intra predictor 1695 may generate a prediction block of the current block according to intra prediction modes in which available peripheral pixels are referred to, and may determine an intra prediction mode according to each reference pixel determination method by determining an intra prediction mode used in obtaining a prediction block having a minimum cost. For example, if all peripheral pixels of a current block of an enhancement layer are available based on the third reference pixel determination method, the intra predictor 1695 may determine an optimum intra prediction mode according to a reference pixel determination method by obtaining prediction blocks of a current block by applying all available intra prediction modes and by determining an intra prediction mode used in obtaining a prediction block having a minimum cost.

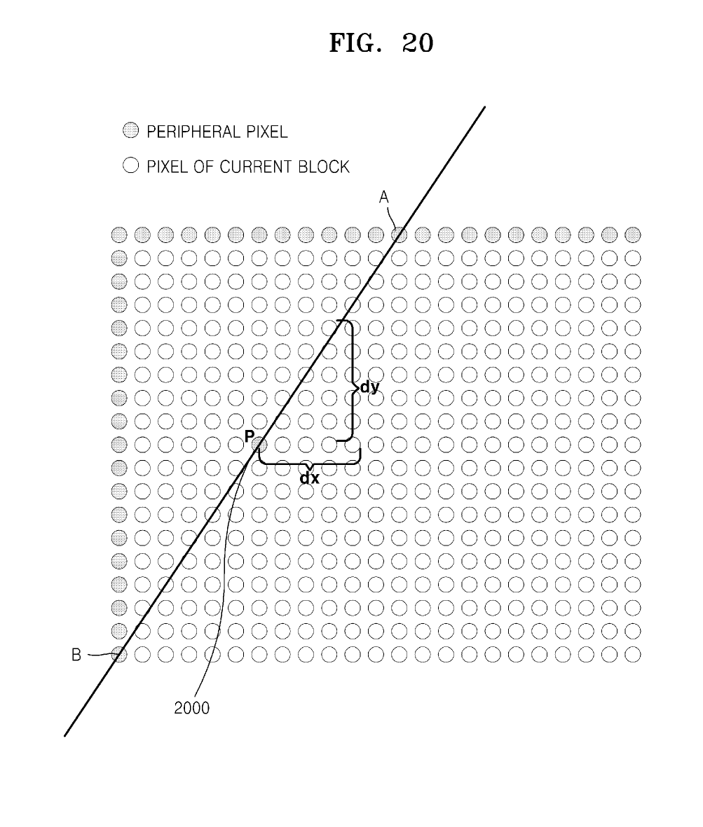

FIG. 20 is a reference diagram for explaining intra prediction modes having various directivities, according to an exemplary embodiment.

The intra prediction modes according to the current exemplary embodiment may have various directivities of tan⁻¹(dy/dx) by using a plurality of (dx, dy) parameters.

Referring to FIG. 20, one of peripheral pixels A and B located along an extension line 2000 having a slope of tan⁻¹(dy/dx) which is determined according to a value of (dx, dy) with respect to a current pixel P that is to be predicted, in a current block, may be used as a predictor of the current pixel P. While only peripheral pixels to the left and above the current block are illustrated in FIG. 20, as described above, unavailable peripheral pixels from among peripheral pixels of the current block of an enhancement layer may be obtained from a base layer image. Intra prediction modes having various directivities as illustrated in FIG. 19 may be defined according to the value of (dx, dy).

FIG. 22 illustrates direct current (DC) intra prediction modes of a current block of an enhancement layer, according to an exemplary embodiment.

When only a peripheral pixel of an enhancement layer is used as a reference pixel according to the first reference pixel determination method, a prediction value of a current block 2200 of an enhancement layer according to a DC mode from among intra prediction modes is an average prediction value of available peripheral pixels 2211 of an enhancement layer. When only a peripheral pixel obtained from a base layer image is used as a reference pixel according to the second reference pixel determination method, a prediction value of the current block 2200 of the enhancement layer according to the DC mode is an average prediction value of the available peripheral pixels 2221 obtained from the base layer image. When an available peripheral pixel of an enhancement layer and peripheral pixels obtained from a base layer image are both used according to the third reference pixel determination method, an average value of all peripheral pixels 2231 of the current block 2200 is a prediction value of the current block 2200 according to the DC mode.

Also, when a planar mode is applied as an intra prediction mode of the current block of the enhancement layer, a peripheral pixel obtained from a base layer image may be used as an unavailable peripheral pixel of the current block of the enhancement layer.

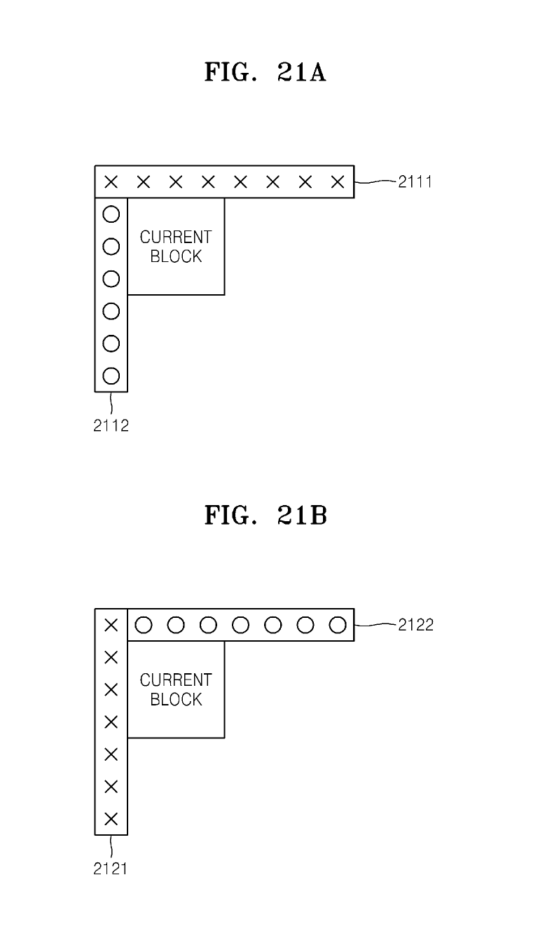

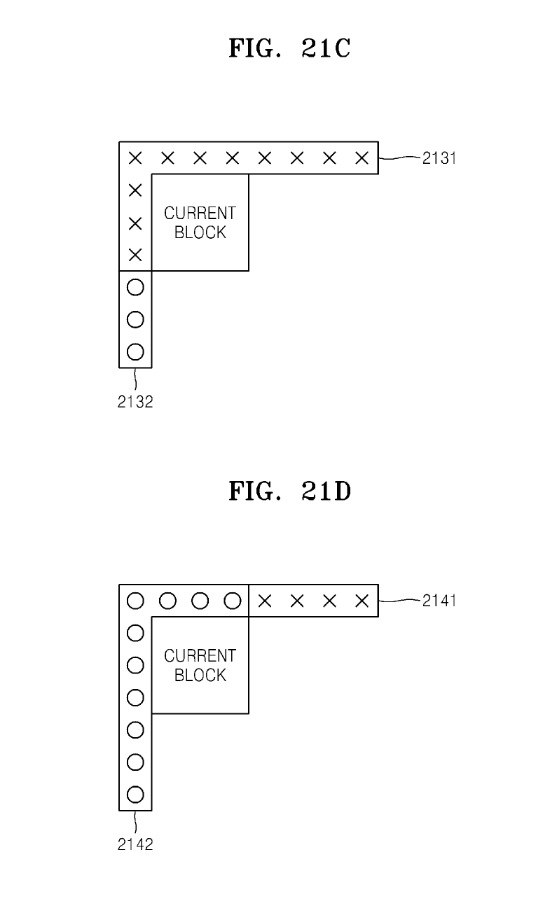

FIGS. 21A through 21D illustrates various examples of obtaining a peripheral pixel of a current block of an enhancement layer from a base layer image, according to an exemplary embodiment.

Referring to FIG. 21A, if left peripheral pixels 2112 of a current block of an enhancement layer are available and upper peripheral pixels 2111 are not available, the upper peripheral pixels 2111 may be obtained by upsampling corresponding upper peripheral pixels of a base layer block. Referring to FIG. 21B, if upper peripheral pixels 2122 of a current block of an enhancement layer are available and left peripheral pixels 2121 are not available, the left peripheral pixels 2121 may be obtained by upsampling corresponding left peripheral pixels of a base layer block. Referring to FIG. 21C, if down left peripheral pixels 2132 of a current block of an enhancement layer are available, and upper and left peripheral pixels 2131 are not available, the upper and left peripheral pixels 2131 may be obtained by upsampling corresponding upper and left peripheral pixels of a base layer block. Referring to FIG. 21D, if upper right peripheral pixels 2141 of a current block of an enhancement layer are available and left and upper left peripheral pixels 2142 are not available, the left and the upper left peripheral pixels 2142 may be obtained by upsampling corresponding upper and left peripheral pixels of a base layer block.

As described above, the intra predictor 1695 of an enhancement layer may obtain peripheral pixels of a current block of an enhancement layer by obtaining unavailable peripheral pixels from among peripheral pixels of a current block of an enhancement layer from corresponding pixel information of a base layer, and may perform intra prediction on the current block according to various intra prediction modes.

As described above, in an explicit mode, when performing intra prediction on a current block of an enhancement layer, an intra prediction value of a current block of an enhancement layer is obtained based on a first reference pixel determination method in which only a peripheral pixel of an enhancement layer is used, a second reference pixel determination method in which only a peripheral pixel obtained from a base layer image is used, and a third reference pixel determination method in which both a peripheral pixel of an enhancement layer and a peripheral pixel obtained from a base layer image are used, and a reference pixel determination method having a minimum cost is included in encoding information of a current block of an enhancement layer.

2) Implicit Mode

In an implicit mode, a reference pixel determination method to be applied to a current block of an enhancement layer is determined based on image information of a base layer or available peripheral pixel information of an enhancement layer that is restored before, and information about the determined reference pixel determination method is not additionally transmitted. Also, in an implicit mode, only flag information indicating that a corresponding peripheral pixel of a base layer block is available is encoded as prediction mode information of a current block of an enhancement layer.

The intra predictor 1695 of an enhancement layer may determine one of the first through third reference pixel determination methods described above based on a difference between a prediction block of a base layer block obtained by using peripheral pixels of a base layer block corresponding to the current block of the enhancement layer and a restored base layer block. In detail, the intra predictor 1695 obtains a first prediction block of a base layer by using only peripheral pixels of a base layer block corresponding to peripheral pixels of an enhancement layer block that is encoded before the enhancement layer block and restored. Also, the intra predictor 1695 obtains a second prediction block of a base layer by using only peripheral pixels of the base layer block corresponding to unavailable peripheral pixels when processing a current block of an enhancement layer. Also, the intra predictor 1695 obtains a third prediction block of a base layer block by using all peripheral pixels of the base layer block.

For example, referring to FIG. 17 again, first, the intra predictor 1695 obtains a first prediction block of a base layer by using left and upper peripheral pixels of the base layer block corresponding to left and upper peripheral pixels from among peripheral pixels 1722 of a current block 1721 of an enhancement layer that are encoded before and then restored, in order to determine one of the reference pixel determination methods in which peripheral pixels of the base layer are selectively used in intra prediction of the current block 1722 of an enhancement layer. Also, the intra predictor 1695 obtains a second prediction block of the base layer based on right and down peripheral pixels 1713 of the base layer block corresponding to right and down peripheral pixels 1723 which are not available in intra prediction of the current block 1721 of the enhancement layer. Also, the intra predictor 1695 obtains a third prediction block of the base layer by using all peripheral pixels of the base layer block.

As described above, in a similar manner to the first through third reference pixel determination methods, the intra predictor 1695 obtains first through third prediction blocks with respect to the base layer block by selectively using peripheral blocks of the base layer block, and determines a prediction block that is most similar to a restored base layer block. If a difference between the first prediction block of the base layer and the restored base layer block is the smallest, the intra predictor 1695 determines the first reference pixel determination method as a reference pixel determination method to be applied to a current block of an enhancement layer. If a difference between the second prediction block of the base layer block and the restored base layer block is the smallest, the intra predictor 1695 determines the second reference pixel determination method as a reference pixel determination method to be applied to a current block of an enhancement layer. If a difference between the third prediction block that is predicted by using all peripheral pixels of the base layer block and the restored base layer block is the smallest, the intra predictor 1695 determines the third reference pixel determination method as a reference pixel determination method to be applied to an enhancement layer block.

In an implicit mode, when performing intra prediction on a current block of an enhancement layer, a method of referring to a peripheral pixel obtained from a base layer may be determined by using information of a base layer image that is previously restored. Accordingly, at the decoder's side, in the same manner as at the encoder's side, first through third prediction blocks of a base layer may be obtained by using information of the base layer image that is restored before, and then the first through third prediction blocks may be compared with the restored base layer block to obtain a prediction block having a smallest difference from the restored base layer block, thereby selecting a reference pixel determination method that is to be applied to a current block of an enhancement layer from among the first through third reference pixel determination methods.

When one of the first through third reference pixel determination methods is determined based on image information of a base layer, the intra predictor 1695 determines at least one of a peripheral pixel of an enhancement layer that is encoded before a current block of the enhancement layer and then restored and a peripheral pixel that is obtained based on a peripheral pixel of a base layer block, as a reference pixel, according to the determined reference pixel determination method, and may apply various intra prediction modes to obtain a prediction block of the current block of an enhancement layer. Also, the intra predictor 1695 determines an intra prediction mode having a minimum cost, as an intra prediction mode of a final current block. In an implicit mode, flag information indicating that a corresponding peripheral pixel of a base layer block is available and determined intra prediction mode information may be encoded as prediction mode information of an enhancement layer block, and information about the first through third reference pixel determination methods indicating methods in which a peripheral pixel obtained from a base layer is selectively used may not be additionally encoded.

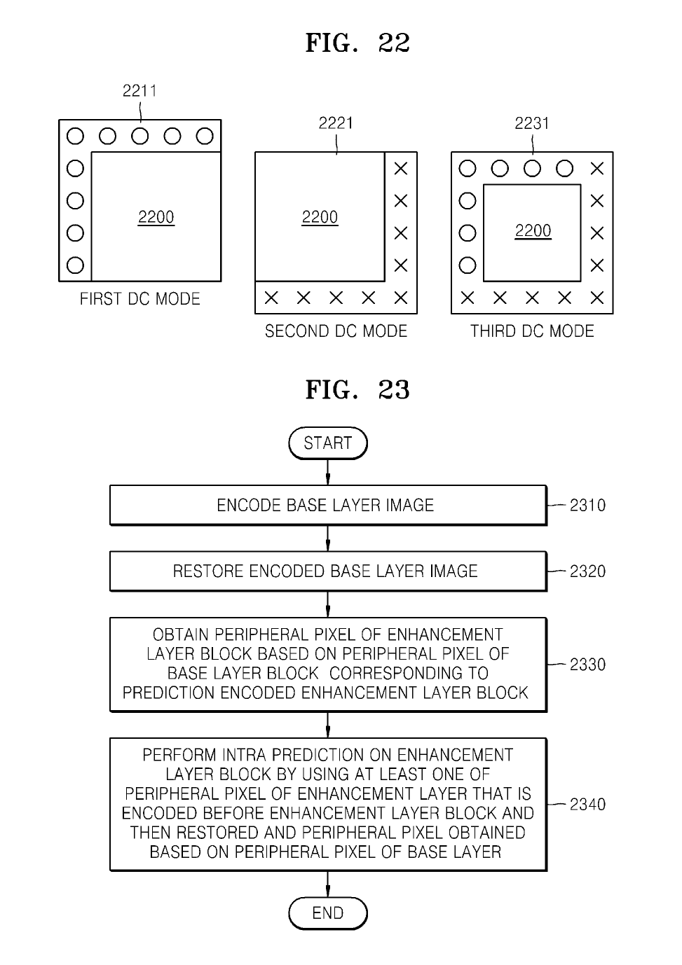

FIG. 23 is a flowchart illustrating a scalable video encoding method according to an exemplary embodiment.

Referring to FIGS. 14 and 23, in operation 2310, the base layer encoder 1410 encodes a base layer image, and in operation 2320, the base layer encoder 1410 restores the encoded base layer image and outputs the same.

In operation 2330, the enhancement layer encoder 1420 obtains a peripheral pixel of an enhancement layer block based on a peripheral pixel of a base layer block corresponding to an enhancement layer block that is prediction encoded. When processing an enhancement layer block, a peripheral pixel of a base layer block corresponding to an unavailable peripheral pixel is upsampled to be used as a reference pixel for intra prediction of the enhancement layer block.

In operation 2340, the enhancement layer encoder 1420 performs intra prediction on an enhancement layer block by using at least one of peripheral pixels of an enhancement layer block obtained based on a peripheral pixel of the enhancement layer block that is encoded before the enhancement block and then restored and a peripheral pixel of a base layer block.

In an explicit mode, when performing intra prediction on a current block of an enhancement layer, an intra prediction value of the current block of the enhancement layer may be obtained based on the first reference pixel determination method in which only a peripheral pixel of the enhancement layer is used, the second reference pixel determination method in which only a peripheral pixel obtained from a base layer image is used, and the third reference pixel determination method in which both a peripheral pixel of the enhancement layer and a peripheral pixel obtained from a base layer image are used, and a reference pixel determination method having a minimum cost is included in encoding information of the current block of the enhancement layer. In an implicit mode, flag information indicating that a corresponding peripheral pixel of a base layer block and the determined intra prediction mode information may only be encoded as prediction mode information of an enhancement layer block, and information about the first through third reference pixel determination methods indicating methods in which a peripheral pixel obtained from a base layer is selectively used may not be additionally encoded. The first through third reference pixel determination methods may be determined based on a difference between a prediction block of a base layer block obtained by using peripheral pixels of the base layer block corresponding to the enhancement layer block and a restored base layer block.

The interlayer intra prediction method according to exemplary embodiments described above may also be applied to multilayer images having a temporal scalability or scalability in terms of image quality besides an image having a spatial scalability.

Meanwhile, a prediction value of an enhancement layer block obtained by using an interlayer intra prediction method according to an exemplary embodiment may be compensated for based on a difference between a quantization parameter of a base layer (hereinafter referred to as a “QP_Base”) and a QP of an enhancement layer (hereinafter referred to as a “QP_Enhance”). When a prediction value of an enhancement layer block obtained by using an interlayer intra prediction method according to an exemplary embodiment is referred to as InterLayer_predicted_enhance, and a compensation value obtained based on a QP of an enhancement layer is referred to as compensation_QP_diff, a compensated prediction value of an enhancement layer, InterLayer_predicted_enhance′, may be obtained based on the equation: InterLayer_predicted_enhance′=InterLayer_predicted_enhance+compensation_QP_diff.

A compensation value compensation_QP_diff may be determined based on an absolute value of a residual of a base layer block which is a difference between a base layer block and the base layer block that is encoded and then restored, and a predetermined factor F (QP_Base, QP_Enhance) that is obtained based on an QP_Base and QP_Enhance. For example, if a residual of a base layer block is Residual_Base, a compensation value compensation_QP_diff may be obtained based on the equation: compensation_QP_diff=Residual_Base*F(QP_Base, QP_Enhance). As described above F(QP_Base, QP_Enhance) is a value that may be obtained based on QP_Base and QP_Enhance, and may be determined, for example, based on a difference between QP_Base and QP_Enhance, or based on an average of differences between QP_Base and QP_Enhance obtained based on encoding information of a base layer image sequence that is encoded before and then restored and an enhancement layer image sequence.

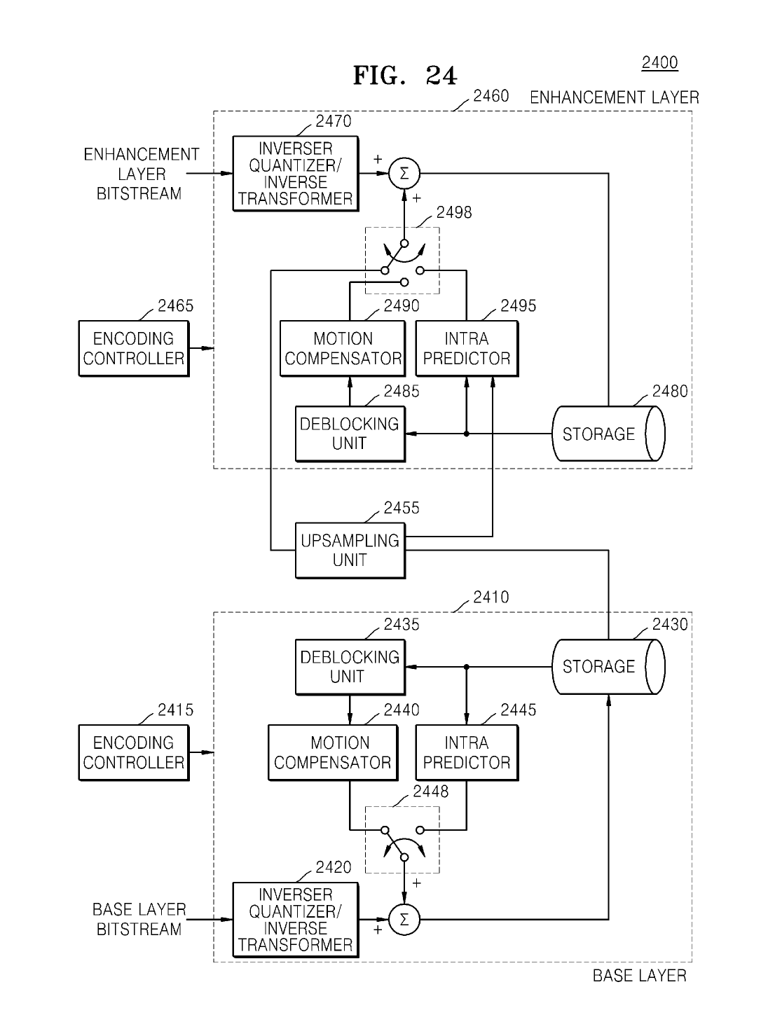

FIG. 24 is a detailed block diagram illustrating a scalable decoding apparatus 2400 according to an exemplary embodiment.

The scalable decoding apparatus 2400 includes a base layer decoding apparatus 2410 and an enhancement layer decoding apparatus 2460. The base layer encoding apparatus 2410 and the enhancement layer decoding apparatus 2460 may respectively correspond to the base layer decoder 1520 and the enhancement layer decoder 1520 of FIG. 15.

First, the base layer decoding apparatus 2410 will be described.

When the parser 1510 parses encoding information of a base layer image and encoding information of an enhancement layer image from a bitstream and outputs the same, an inverse quantizer/inverse transformer 2420 inversely quantizes and inversely transforms a residual of a base layer image to output restored residual information. A motion compensator 2440 performs inter prediction on a current block to output a prediction block of the current block, and an intra predictor 2445 performs intra prediction on the current block to output a prediction block of the current block. A decoding controller 2415 determines a prediction mode of the current block from among an intra prediction mode and an inter prediction mode based on prediction mode information of the current block of a base layer included in encoding information of the base layer image, and controls a prediction switch 2448 such that a prediction block of the determined prediction mode is output. The prediction block of the current block that is obtained by intra prediction or inter prediction and the restored residual are added to restore the current block of the base layer. The restored current block of the base layer is stored in a storage 2430. A deblocking unit 2435 performs deblocking filtering with respect to the restored base layer image. The upsampling unit 2455 upsamples the base layer image to output an upsampled image corresponding to an enhancement layer image.

Next, the enhancement layer decoding apparatus 2460 will be described in detail.

An inverse quantizer/inverse transformer 2470 inversely quantizes and inversely transforms a residual of an enhancement layer image to output restored residual information. A motion compensator 2490 performs inter prediction on a current block of an enhancement layer to output a prediction block, and an intra predictor 2495 performs intra prediction on the current block of the enhancement layer to output a prediction block. A decoding control unit 2465 determines a prediction mode of a current block of an enhancement layer from among an intra prediction mode and an inter prediction mode based on prediction mode information of the current block of the enhancement layer included in the encoding information of the enhancement layer image, and controls a prediction switch 2498 such that a prediction block according to the determined prediction mode is output. The prediction block of the current block that is obtained by intra prediction or inter prediction and the restored residual are added to restore the current block of the base layer. The restored current block of the base layer is stored in a storage 2480. A deblocking unit 2485 performs deblocking filtering with respect to the restored enhancement layer image.

In particular, the intra predictor 2495 of an enhancement layer according to the current exemplary embodiment performs intra prediction on a current block of an enhancement layer by selectively using a peripheral pixel of a current block of an enhancement layer that is restored before the current block of the enhancement layer and a peripheral pixel of a base layer block.

If information about a reference pixel determination method is included in encoding information of the current block of the enhancement layer according to an explicit mode, the intra predictor 2495 of an enhancement layer may use only peripheral pixels of the current block of the enhancement layer that is restored before the current block of the enhancement layer (the first reference pixel determination method) as a reference pixel, or only peripheral pixels that are obtained based on a peripheral pixel of a base layer block corresponding to the current block of the enhancement layer (the second reference pixel determination method) as a reference pixel, or both a peripheral pixel of an enhancement layer that is restored before the current block of the enhancement layer and a peripheral pixel of a current block of an enhancement layer that is obtained based on a peripheral pixel of a base layer block as a reference pixel (the third reference pixel determination method). Also, the intra predictor 2495 of an enhancement layer performs intra prediction on an enhancement layer block by using at least one of a peripheral pixel of an enhancement layer block that is decoded before the enhancement layer block and a peripheral pixel of an enhancement layer block that is obtained based on a peripheral pixel of a base layer block, based on intra prediction mode information of the enhancement layer.

If only flag information indicating whether a base layer block is used is included in encoding information of a current block of an enhancement layer according to an implicit mode, the intra predictor 2495 of an enhancement layer may determine a reference pixel determination method to be applied to the current block of the enhancement layer from among the first through third reference pixel determination methods by obtaining first through third prediction blocks of a base layer by using information of a base layer image that is restored before in the same manner as at the encoder's end, and then by obtaining a prediction block having a smallest difference from a restored base layer block. Also, the intra predictor 2495 of an enhancement layer performs intra prediction on an enhancement layer block by using at least one of a peripheral pixel of an enhancement layer block that is decoded before the enhancement layer block and a peripheral pixel of an enhancement layer block that is obtained based on a peripheral pixel of a base layer block, based on intra prediction mode information of the enhancement layer.

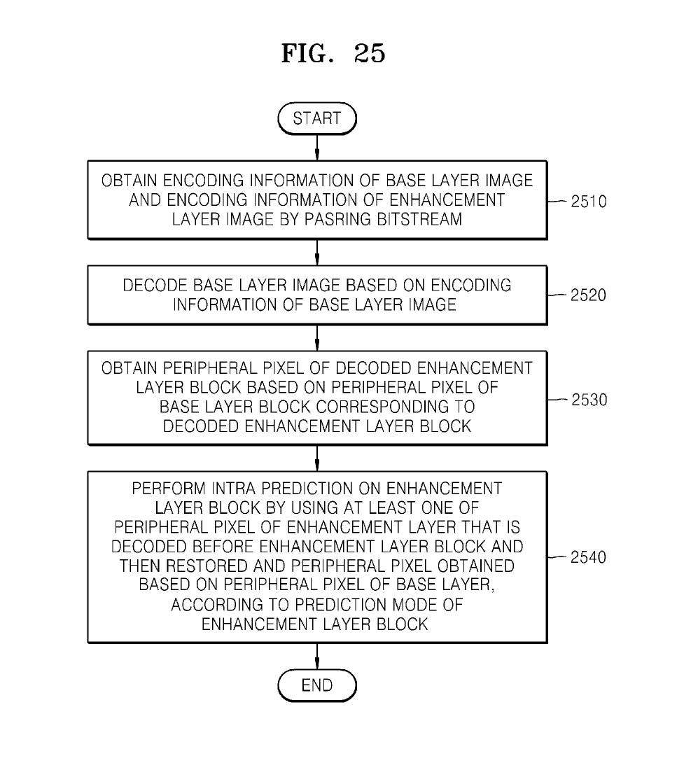

FIG. 25 is a flowchart illustrating a scalable video decoding method according to an exemplary embodiment.

Referring to FIGS. 15 and 25, in operation 2510, the parser 1510 parses a bitstream to obtain encoding information of a base layer image and encoding information of an enhancement layer image.

In operation 2520, the base layer decoder 1520 decodes a base layer image based on encoding information of the base layer image.

In operation 2530, the enhancement layer decoder 1530 obtains a peripheral pixel of an enhancement layer block based on a corresponding peripheral pixel of a base layer block that is decoded. As described above, if information about a reference pixel determination method is included in encoding information of a current block of an enhancement layer according to an explicit mode, the enhancement layer decoder 1530 determines one of the first through third reference pixel determination methods based on the obtained reference pixel determination method, and may determine a reference pixel to be used in intra prediction of an enhancement layer block according to the determined reference pixel determination method. If only flag information indicating whether a base layer block is used is included in encoding information of a current block of an enhancement layer according to an implicit mode, the enhancement layer decoder 1530 may determine a reference pixel determination method to be applied to a current block of an enhancement layer from among the first through third reference pixel determination methods by obtaining first through third prediction blocks of a base layer by using information of a base layer image that is restored previously in the same manner as at the encoder's end, and then obtaining a prediction block having a smallest difference from the restored base layer block by comparing the first through third prediction blocks with the restored base layer block.

In operation 2540, the enhancement layer decoder 1530 performs intra prediction on an enhancement layer block by using at least one of a peripheral pixel of the enhancement layer block is decoded before the enhancement block and a peripheral pixel of the enhancement layer block that is obtained based on a peripheral pixel of a base layer block, according to a prediction mode of the enhancement layer block obtained from the bitstream.

As described above, according to the one or more of the above exemplary embodiments, an enhancement layer image is prediction encoded by using peripheral pixels in various directions to improve intra prediction performance and a compression efficiency of the enhancement layer image.

Exemplary embodiments can also be embodied as computer readable codes on a computer readable recording medium. The computer readable recording medium is any data storage device that can store data which can be read by a computer device. Examples of the computer readable recording medium include read-only memory (ROM), random-access memory (RAM), CD-ROMs, magnetic tapes, floppy disks, optical data storage devices, and so on. The computer readable recording medium can also be distributed over network coupled computer systems so that the computer readable code is stored and executed in a distributed fashion.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A scalable video encoding method comprising:
encoding a base layer block;
restoring the encoded base layer block;
obtaining a peripheral pixel of an enhancement layer block based on a peripheral pixel of the base layer block corresponding to the enhancement layer block to be prediction-encoded; and
performing intra prediction on the enhancement layer block by using at least one of a peripheral pixel of an enhancement layer block that is encoded before the enhancement layer block and then restored and the peripheral pixel of the enhancement layer block that is obtained based on the peripheral pixel of the base layer block.

2. The scalable video encoding method of claim 1, wherein the obtaining a peripheral pixel of the enhancement layer block comprises obtaining the peripheral pixel of the enhancement layer block by upsampling the peripheral pixel of the base layer block corresponding to an unavailable peripheral pixel when processing the enhancement layer block.

3. The scalable video encoding method of claim 1, wherein the performing intra prediction comprises:
obtaining a prediction block of the enhancement layer block by using at least one of a peripheral pixel of the enhancement layer block that is encoded before the enhancement layer block and then restored and the peripheral pixel of the enhancement layer block that is obtained based on the peripheral pixel of the base layer block, according to predetermined intra prediction modes; and
determining an intra prediction mode having a minimum cost from among the intra prediction modes by comparing costs of prediction blocks of the enhancement layer block according to the intra prediction modes.

4. The scalable video encoding method of claim 1, wherein the performing intra prediction comprises:
obtaining a first prediction block of the enhancement layer block by using a first reference pixel determination method in which only peripheral pixels of the enhancement layer block, which is encoded before the enhancement layer block and then restored, are used as reference pixels;
obtaining a second prediction block of the enhancement layer block by using a second reference pixel determination method in which only peripheral pixels of the enhancement layer block that are obtained based on the peripheral pixel of the base layer block are used as reference pixels;
obtaining a third prediction block of the enhancement layer block by using a third reference pixel determination method in which both the peripheral pixel of the enhancement layer block that is encoded before the enhancement layer block and then restored and the peripheral pixel of the enhancement layer block that is obtained based on the peripheral pixel of the base layer block are used as reference pixels; and
determining a reference pixel determination method for obtaining a prediction block having a minimum cost by comparing costs of the first, second, and third prediction blocks.

5. The scalable video encoding method of claim 4, further comprising encoding information about the determined reference pixel determination method as prediction mode information of the enhancement layer block.

6. The scalable video encoding method of claim 1, wherein the performing intra prediction comprises determining one of a first reference pixel determination method in which only peripheral pixels of the enhancement layer block, which is encoded before the enhancement layer block and then restored, are used, a second reference pixel determination method in which only peripheral pixels of the enhancement layer block that are obtained based on the peripheral pixel of the base layer block are used, and a third reference pixel determination method in which both the peripheral pixel of the enhancement layer block that is encoded before the enhancement layer block and then restored and the peripheral pixel of the enhancement layer block that is obtained based on the peripheral pixel of the base layer block are used as a reference pixel determination method to be applied to the enhancement layer block, based on a difference between a prediction block of the base layer block obtained by using peripheral pixels of the base layer block corresponding to the enhancement layer block and the base layer block.

7. The scalable video encoding method of claim 6, wherein the performing intra prediction comprises:
determining the first reference pixel determination method as a reference pixel determination method to be applied to the enhancement layer block if a difference between the prediction block of the base layer block, which is predicted by using only peripheral pixels of the base layer block corresponding to peripheral pixels of the enhancement layer block that are encoded before the enhancement layer block and then restored, and the base layer block is the smallest;
determining the second reference pixel determination method as a reference pixel determination method to be applied to the enhancement layer block if a difference between the prediction block of the base layer block, which is predicted by using only peripheral pixels of the base layer block corresponding to unavailable peripheral pixels when processing the enhancement layer block, and the base layer block is the smallest; and
determining the third reference pixel determination method as a reference pixel determination method to be applied to the enhancement layer block if a difference between the prediction block of the base layer block, which is predicted by selectively using all peripheral pixels of the base layer block, and the base layer block is the smallest.

8. The scalable video encoding method of claim 6, wherein flag information indicating that the peripheral pixel of the corresponding base layer block is used as reference pixel information of the enhancement layer block is encoded as prediction mode information of the enhancement layer block, and encoding of information about the reference pixel determination method applied to the enhancement layer block is skipped.

9. A scalable video encoding apparatus comprising:
a base layer encoder which is configured to encode a base layer block; and
an enhancement layer encoder which is configured to obtain a peripheral pixel of an enhancement layer block based on a peripheral pixel of the base layer block corresponding to the enhancement layer block to be prediction-encoded, and to prediction encode the enhancement layer block by performing intra prediction on the enhancement layer block by using at least one of a peripheral pixel of an enhancement layer block that is encoded before the enhancement layer block and then restored, and the peripheral pixel of the enhancement layer block obtained based on the peripheral pixel of the base layer block.

10. A scalable video decoding method comprising:
obtaining encoding information of a base layer block and encoding information of an enhancement layer block by parsing a bitstream;
decoding the base layer block based on the encoding information of the base layer block;
obtaining a peripheral pixel of the enhancement layer block based on a peripheral pixel of the decoded base layer block corresponding to the enhancement layer block; and
performing intra prediction on the enhancement layer block by using at least one of a peripheral pixel of an enhancement layer block that is restored before the enhancement layer block and the peripheral pixel of the enhancement layer block that is obtained based on the peripheral pixel of the base layer block, according to a prediction mode of the enhancement layer block.

11. The scalable video decoding method of claim 10, wherein the obtaining a peripheral pixel of the enhancement layer block comprises obtaining a peripheral pixel of the enhancement layer block by upsampling a peripheral pixel of the base layer block corresponding to an unavailable peripheral pixel when processing the enhancement layer block.

12. The scalable video decoding method of claim 10, wherein the performing intra prediction comprises, if, according to an intra prediction mode of the enhancement layer block obtained from the bitstream, there is an unavailable peripheral pixel from among peripheral pixels used in intra prediction of the enhancement layer block, a peripheral pixel of the base layer block corresponding to the unavailable peripheral pixel of the enhancement layer block is determined as a peripheral pixel of the enhancement layer block.

13. The scalable video decoding method of claim 10, wherein the performing intra prediction comprises determining one of a first reference pixel determination method in which only peripheral pixels of the enhancement layer block, which is restored before the enhancement layer block, are used, a second reference pixel determination method in which only peripheral pixels of the enhancement layer block that are obtained based on the peripheral pixel of the base layer block are used, and a third reference pixel determination method in which both the peripheral pixel of the enhancement layer block that is encoded before the enhancement layer block and then restored and the peripheral pixel of the enhancement layer block that is obtained based on the peripheral pixel of the base layer block are used as a reference pixel determination method to be applied to the enhancement layer block, based on a difference between a prediction block of the base layer block obtained by using peripheral pixels of the base layer block corresponding to the enhancement layer block and the base layer block.

14. The scalable video decoding method of claim 13, wherein the performing intra prediction comprises:
determining the first reference pixel determination method as a reference pixel determination method to be applied to the enhancement layer block if a difference between the prediction block of the base layer block, which is predicted by using only peripheral pixels of the base layer block corresponding to peripheral pixels of the enhancement layer block that are restored before the enhancement layer block, and the base layer block is the smallest;
determining the second reference pixel determination method as a reference pixel determination method to be applied to the enhancement layer block if a difference between the prediction block of the base layer block, which is predicted by using only peripheral pixels of the base layer block corresponding to unavailable peripheral pixels when processing the enhancement layer block, and the base layer block is the smallest; and
determining the third reference pixel determination method a reference pixel determination method to be applied to the enhancement layer block if a difference between the prediction block of the base layer block, which is predicted by selectively using all peripheral pixels of the base layer block, and the base layer block is the smallest.

15. A scalable video decoding apparatus comprising:
a parser which is configured to obtain encoding information of a base layer block and encoding information of an enhancement layer block by parsing a bitstream;
a base layer decoder which is configured to decode the base layer block based on the encoding information of the base layer block; and
an enhancement layer decoder which is configured to decode a peripheral pixel of the enhancement layer block based on a peripheral pixel of the decoded base layer block corresponding to the enhancement layer block, and performs intra prediction on the enhancement layer block by using at least one of a peripheral pixel of an enhancement layer block that is decoded before the enhancement layer block and the peripheral pixel of the enhancement layer block that is obtained based on the peripheral pixel of the base layer block, according to a prediction mode of the enhancement layer block.
